(19) United States
(12) Patent Application Publication
(10) Pub. No.: US 2019/0391731 A1
(43) Pub. Date: Dec. 26, 2019

(54) METHOD AND SYSTEM FOR MANUFACTURING A CUSTOM DESIGNED CONTAINER PACKAGE AND INSERTS

(71) Applicant: CASES BY SOURCE INC., Mahwah, NJ (US)

(72) Inventors: Matthew Adler, Mahwah, NJ (US); Jeffrey Chookazian, Mahwah, NJ (US)

(73) Assignee: CASES BY SOURCE INC., Mahway, NJ (US)

(21) Appl. No.: 16/561,171

(22) Filed: Sep. 5, 2019

Related U.S. Application Data
(63) Continuation-in-part of application No. 15/092,068, filed on Apr. 6, 2016, now Pat. No. 10,417,683.

(51) Int. Cl. G06F 3/0484; G06F 3/0481; G06F 3/0482; G06Q 30/06

(52) U.S. Cl. CPC G06F 3/04845; G06F 3/04817; G06F 3/0482; G06Q 30/0643; G06F 3/04847; G06Q 30/0621; G06Q 30/0633; G06F 3/04842

(57) ABSTRACT

A method and system for manufacturing a custom designed container or package and an insert received in the container or package by selecting a size of the container or package using a size graphical user interface of a graphical user interface displayed on a display device. The custom foam insert can be designed using an insert shape graphical user interface displayed on the display device. The custom foam insert includes one or more cavities corresponding to respective one or more features of one or more objects to be retained in the container or package.

### CROSS-REFERENCE TO RELATED APPLICATION

This application is a continuation-in-part of application Ser. No. 15/092,068, filed on Apr. 6, 2016, which is incorporated by reference in its entirety.

### FIELD

The present invention relates to computer implemented methods and systems for creating a user-driven custom designed insert for a container or package and methods for selling the custom designed products online to the general public.

### BACKGROUND

Open cell foam and closed cell foam have been used in shipping containers for protection of contents therein. An example open cell foam has been manufactured in predetermined shapes and sizes for cases and packaging by the FOAM FACTORY as Pick and Pluck charcoal foam. The foam can be separated by hand to fit around an object.

U.S. Pat. No. 6,695,141 describes a container package for holding an entire computer system including a monitor, a computer case and a printer. A first foam insert has a flat bottom surface and a formed upper surface matched to the shape of a portion of the monitor and a portion of the computer case. A second foam insert has a formed lower surface matched to the shape of another portion of the monitor and another portion of the computer case and a formed upper surface matched to a portion of the printer. A third foam insert has a formed lower surface matched to another portion of the printer and a flat upper surface. A container includes a lower portion and an upper portion. The first foam portion is positionable in a lower portion of the container and an upper portion is positionable over the first foam insert, the second foam insert, the third foam insert and the monitor, the computer case, and the printer.

It is desirable to provide a method and system for creating user-driven custom designed containers or packages and inserts for packaging user selected objects.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The present application relates to a method for manufacturing a custom designed container or package and an insert received in the container or package by selecting a size of the container or package using a size graphical user interface of a graphical user interface displayed on a display device. The custom foam insert can be designed using an insert shape graphical user interface displayed on the display device. The custom foam insert includes one or more cavities corresponding to respective one or more features of one or more objects to be retained in the container or package.

In one embodiment, the size of a container or package can be selected by providing a template at the size graphical user interface to instruct a user to place objects to be packaged on a flat surface in a layout. One or more graphical common objects are displayed on the display device. One of the graphical common objects can be selected to best match the layout for determining the size of the container or package.

In one embodiment, the design of the custom foam insert can be performed by causing one or more shapes to be displayed on the display device by the graphical user interface, selecting one or more of the displayed shapes and spacing the one or more selected shapes on the display device. In one aspect, a user places a first one of the selected shapes at a position of a right most point of a starting canvas and the user places a second one of the selected shapes a position of a left most point of the starting canvas. The remaining one or more of the selected shapes are automatically spaced evenly between the first one of the selected shapes and the second one of the selected shapes on the display device.

Alternatively, the custom foam insert can be designed by uploading a photograph of the one or more objects using the insert shape graphical user interface displayed on the display device, creating a trace representation of the uploaded photograph on the display device, and saving the trace representation to a memory as a data file in a user's library. A user can also adjust detail of the trace on the display device. By using a design tool, a user can add or remove points or paths from the trace. Once a user confirms traced points, the design tool can crop the canvas to the outermost points of the shape. The user can be prompted to input an object depth and length. The depth is the distance the cavity goes into the foam. The length is the object's left most point to the right most point. These measurements can be used to scale the traced shape.

The shapes stored in the user's library are only accessible to the specific user when logged in. By saving shapes to the user's library the user can access the shapes at a later date. If the user frequently uses a particular shape in a different container or package the user does not need to upload the photograph every time. The library allows the user to upload the photograph once and then use the determined shape multiple times.

The type of the foam used in the insert can be changed at any time during the design process. When the new foam type is selected a price of the insert dynamically changes.

In one embodiment, the present invention provides causing a metric to imperial toggle icon to be displayed on the display device. The metric to imperial toggle icon can be activated to switch between metric and imperial measurement standards in real time used in determining the size of the container or package.

In one embodiment, the present invention provides causing a zoom icon to be displayed on the graphical user interface on the display device. The zoom icon is activated to size the starting canvas to a pre-determined value. For example, the user's screen can be locked in a 1:1 ratio. In one embodiment, validation rules are integrated into the steps for creating the custom insert.

In one embodiment the present invention is directed to web-based software for creating custom designed foam inserts for containers or packages to enables users to select a specific case, design a custom foam insert, and then submit an online order using a shopping cart. Alternatively, a user can launch a pre-designed case and insert, modify the design of the insert and then checkout. In one embodiment, the user can forward the design in a shopping cart to someone else to make a purchase. Any or all of the items listed above may be implemented by a custom designed container or package and insert system that includes a data storage facility, a processor, and computer-readable medium containing programming instructions that, when executed, instruct the processor to perform various functions. While generally described as computer implemented software embodied on non-transitory media that processes and transforms the respective data, some or all of the aspects may be computer implemented methods or further included in respective systems or other devices for performing this described functionality.

In an alternative embodiment, the present invention is a method for creating packaging for retaining an object comprising the steps of: selecting overall dimensions of the packaging using an input device; selecting a component of the packaging using the input device; and manufacturing the packaging having the overall dimensions and the component using a manufacturing system, thereby creating the packaging. The step of selecting of the overall dimensions of the packaging includes the step of: selecting interior dimensions of a cavity within the packaging. The step of selecting the component includes the step of: selecting an interior padding of the packaging. The step of selecting the component includes the step of: selecting a lid of the packaging. The step of selecting the component includes the step of: selecting a material from which the packaging is composed. The step of selecting the component includes the step of: selecting a wheel of the packaging. The step of selecting the component includes the step of: selecting a branding of the packaging. The method further comprises the step of: displaying details about the overall dimensions and the component for review on an output device. The steps of selecting the overall dimensions and selecting the component are performed using a web-based service. The steps of selecting the overall dimensions and selecting the component are performed using a graphical user interface (GUI).

In another alternative embodiment, the present invention is a system for creating packaging for retaining an object comprising: an input device for allowing a user to select overall dimensions of the packaging and to select a component of the packaging; and a manufacturing system for manufacturing the packaging having the overall dimensions and the component, thereby creating the packaging. The system further comprises a web server for implementing a web-based service for selecting the overall dimensions and selecting the component. The system further comprises an output device for displaying details about the overall dimensions and the component for review. At least one of the input device and the output device includes a graphical user interface (GUI).

In a further embodiment, the present invention is a method for manufacturing a custom foam insert insertable into a packaging for an object comprising the steps of: displaying a graphical user interface (GUI) on an input/output device; displaying a template on the GUI to instruct the user to place the object to be packaged in the packaging on a flat surface in a layout; designing the custom foam insert using the GUI, the custom foam insert including a cavity corresponding to a feature of the object; and manufacturing the custom foam insert using a manufacturing system, wherein the custom foam insert is sized to be received in the packaging, and the custom foam insert is adapted to receive the object. The step of designing the custom foam insert further comprises the steps of: launching a pop-up foam type window on the GUI for displaying a plurality of foam types which can be selected by the user; and selecting one of the displayed foam types. The step of designing the custom foam insert further comprises the steps of: uploading a photograph of the object; creating a trace representation of the uploaded photograph on the GUI; and saving the trace representation as an insert representation to a memory as a data file in a library associated with the user. The uploaded photograph is a bitmap, and the step of creating the trace representation converts the bitmap to vector graphics. The step of creating the trace representation of the uploaded photograph further comprises the steps of: displaying an input object depth template and an input object length template on the GUI; inputting a depth of the object in the input depth template and a length of the object in the input object length template; and scaling the trace representation using the depth and the length. The method further comprises the steps of: displaying a starting canvas on the GUI; and sizing the starting canvas to a predetermined value.

The invention will be more fully described by reference to the following drawings.

### BRIEF DESCRIPTION OF DRAWINGS

The foregoing summary, as well as the following detailed description of presently preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a flow diagram for a method for manufacturing a custom designed container or package and an insert.

FIG. 2 is a schematic diagram of a user interface used to trigger a graphical user interface in the method for manufacturing a custom designed container or package and insert.

FIG. 3 is a schematic diagram of a graphical user interface used in the method for manufacturing a custom designed container or package and insert.

FIG. 4 is a schematic diagram of a display size graphical user interface used in the method for manufacturing a custom designed container or package and insert.

FIG. 5A is a schematic diagram of a find me a case button on a design tool graphical user interface.

FIG. 5B is a schematic diagram of a user interface for finding a case.

FIG. 6 is a schematic diagram of foam type user interface and templates used in the method for manufacturing a custom designed container or package and insert.

FIG. 7 is a schematic diagram of an insert shape graphical user interface used in the method for manufacturing a custom designed container or package and insert.

FIG. 8 is a schematic diagram of a photo trace window used in the method for manufacturing a custom designed container or package and insert.

FIG. 9 is a flow diagram of steps that can be used by a photo trace design tool to auto trace an object in the photograph and save the trace to a user's library.

FIG. 10 is a schematic diagram of traced object used in the method for manufacturing a custom designed container or package and insert.

FIG. 11 is a schematic diagram of an add shape icon which is activated to save a traced object to a user's shape library used in the method for manufacturing a custom designed container or package and insert.

FIG. 12 is a schematic diagram of a zoom icon used in the method for manufacturing a custom designed container or package and insert.

FIG. 13 is a schematic diagram of a zoom actual icon and zoom template used in the method for manufacturing a custom designed container or package and insert.

FIG. 14 is a schematic diagram of a user leave window template used in the method for manufacturing a custom designed container or package and insert.

FIG. 15 is a schematic diagram of an off limits area and starting canvas used in the method for manufacturing a custom designed container or package and insert.

FIG. 16 is a schematic diagram of a custom foam which can displayed showing design of a custom foam insert used in the method for manufacturing a custom designed container or package and insert.

FIG. 17 is a schematic diagram of an add custom foam icon which can be activated to modify the design of custom foam insert used in the method for manufacturing a custom designed container or package and insert.

FIG. 18 is a schematic diagram of metric to imperial toggle icon used in the method for manufacturing a custom designed container or package and insert.

FIG. 19 is a schematic diagram of a validation rules icon used in the method for manufacturing a custom designed container or package and insert.

FIG. 20 is a schematic diagram of an add cavity icon used in the method for manufacturing a custom designed container or package and insert.

FIG. 21 is a schematic diagram of a purchase window used in the method for manufacturing a custom designed container or package and insert.

FIG. 22 is a schematic diagram of a user order confirmation email used in the method for manufacturing a custom designed container or package and insert.

FIG. 23 is a schematic diagram of third party request for order confirmation email used in the method for manufacturing a custom designed container or package and insert.

FIG. 24 is a schematic diagram of a system that can be used to implement various embodiments of the processes of the present invention.

FIG. 25 is a schematic diagram of a system of the present invention.

FIG. 26 is a flowchart of a method of the present invention.

FIG. 27 is another flowchart of a method of the present invention.

FIG. 28 is a graphic user interface for setting a type of units and a type of packaging.

FIG. 29 is the graphic user interface of FIG. 28 for selecting interior dimensions.

FIG. 30 is a graphic user interface for asking the user to check the interior dimensions.

FIG. 31 is a graphic user interface for selecting a branding of the packaging.

FIG. 32 is a list of packaging details.

FIG. 33 is a list of user details.

FIG. 34 is a graphic user interface showing a user profile and associated packagings.

FIG. 35 is a graphic user interface for managing prices of parts and other parameters.

FIG. 36 is the graphic user interface of FIG. 35 with a pop-up window for pricing parts.

FIG. 37 is a graphic user interface for managing user information.

FIG. 38 is a graphic user interface for registering a user.

FIG. 39 is a graphic user interface for logging in a user.

FIG. 40 is a graphic user interface for selecting a lid of the packaging.

FIG. 41 is a graphic user interface for selecting materials of the packaging.

FIG. 42 is a graphic user interface for selecting wheels of the packaging.

FIG. 43 is a graphic user interface for reviewing a first set of product details.

FIG. 44 is a graphic user interface for reviewing a second set of product details.

FIG. 45 is a graphic user interface providing an online shopping cart.

To facilitate an understanding of the invention, identical reference numerals have been used, when appropriate, to designate the same or similar elements that are common to the figures. Further, unless stated otherwise, the features shown in the figures are not drawn to scale, but are shown for illustrative purposes only.

### DETAILED DESCRIPTION

Certain terminology is used in the following description for convenience only and is not limiting. The article “a” is intended to include one or more items, and where only one item is intended the term “one” or similar language is used. Additionally, to assist in the description of the present invention, words such as top, bottom, side, upper, lower, front, rear, inner, outer, right and left may be used to describe the accompanying figures. The terminology includes the words above specifically mentioned, derivatives thereof, and words of similar import.

Reference will now be made in greater detail to a preferred embodiment of the invention, an example of which is illustrated in the accompanying drawings. Wherever possible, the same reference numerals will be used throughout the drawings and the description to refer to the same or like parts.

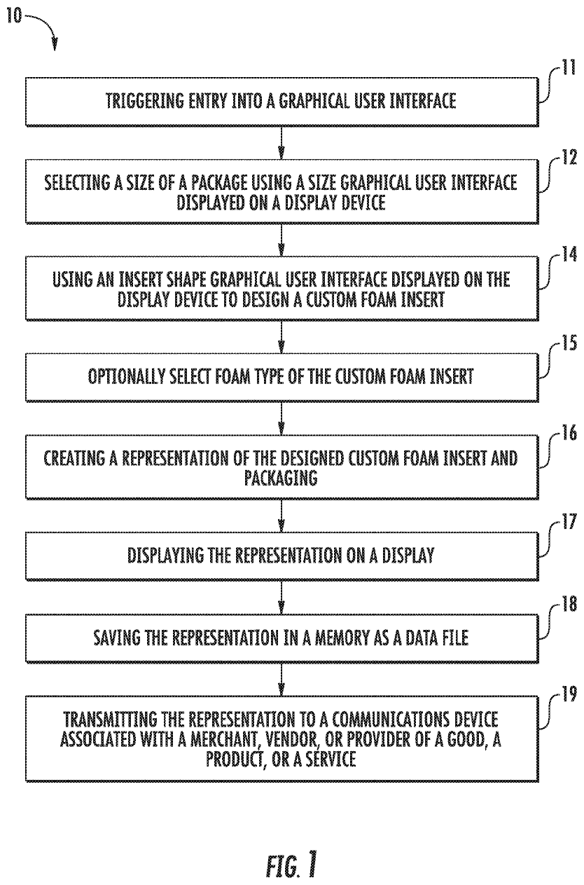

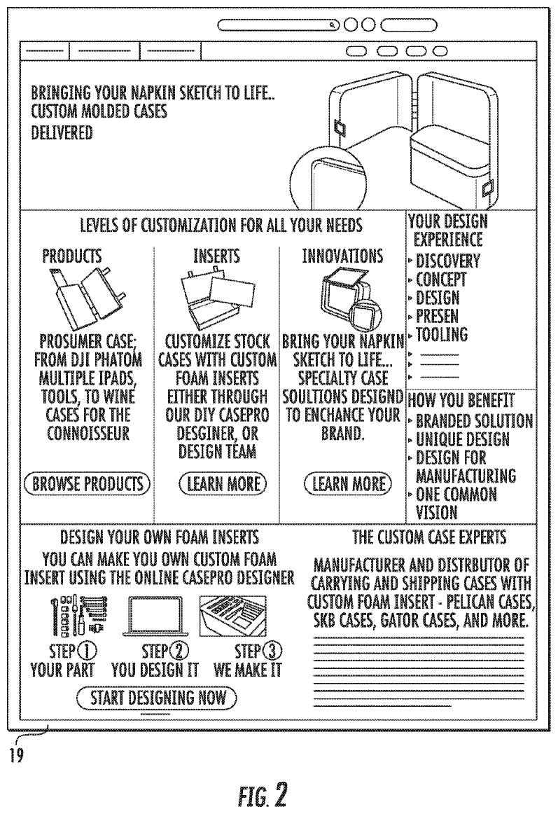

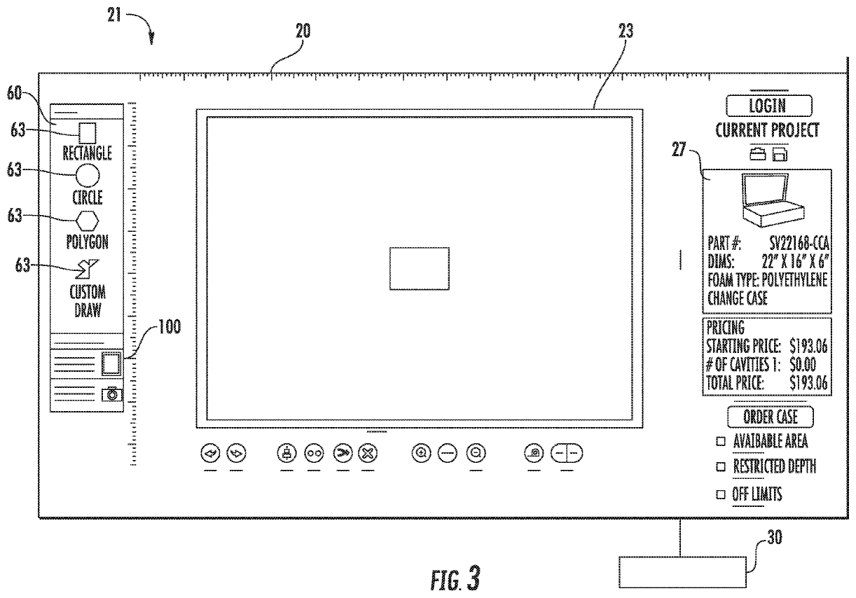

FIG. 1 is a flow diagram of a method for manufacturing a custom designed container or package and an insert 10 including steps that a system for manufacturing a custom designed container or package and insert can follow in accordance with the teachings of the present invention. In block 11, a design icon is selected to trigger entry into a design tool graphical user interface. In one embodiment, design icon 19 is selected at user interface 21 on display 24 as shown in FIG. 2. In block 12, a size of a package is selected at a user interface. In one embodiment, design tool graphical user interface 20 is displayed at user interface 21 after being triggered by design icon 19 and is used at user interface 21 as shown in FIG. 3. User interface 21 provides output to and receives input from a user. The user interface can include a display, audio output, a printer or another element that provides information to a user. User interface 21 can also include a touch sensitive component, microphone, audio port, keyboard, mouse, touchpad or other input mechanism that is capable of receiving user input. Design tool graphical user interface 20 can display starting canvas 23 which can be used for selecting a size of a container or package on display 24. Design tool graphical user interface 20 can be implemented using design tool 30. In one embodiment, design tool 30 can be developed using SVG-edit. SVG-edit is a web-based, JavaScript-driven SVG drawing editor that works in conventional browsers.

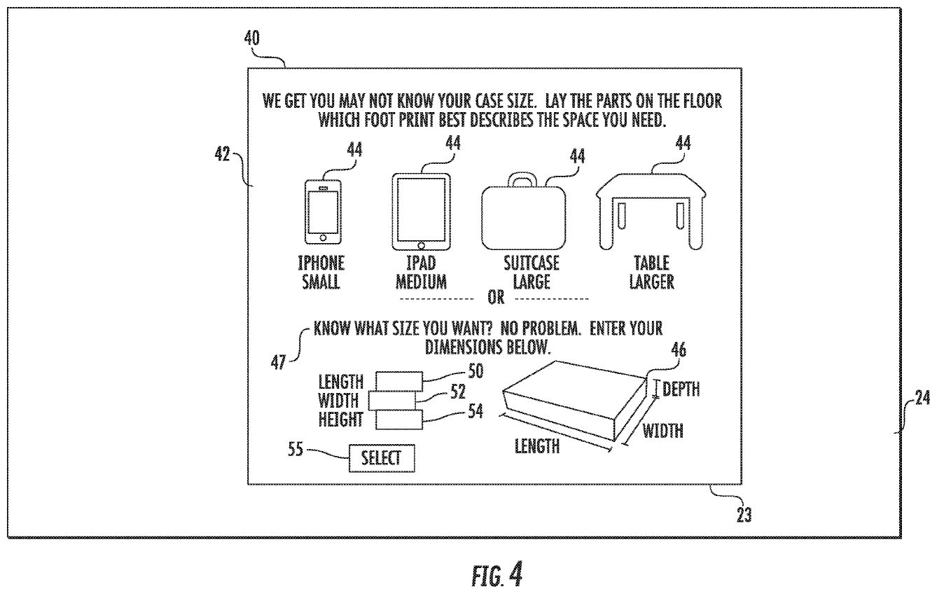

Design icon 19 can be activated to display size graphical user interface 40 on display 24 as shown in FIG. 4. Template 42 of size graphical user interface 40 can be used to instruct a user to place objects to be packaged on a flat surface, for example the floor. The user is directed to layout the objects according to how the objects would be located in a package. Size graphical user interface 40 displays graphical common objects 44. Graphical common objects 44 represent size options for the container or package. Example containers or packages include cases, housings, cartons, boxes and the like. One or more of graphical objects 44 can be selected by the user to best match the layout of the objects that the user desires be retained in the container or package. From the selected graphical common object 44 a size of starting canvas 23 can be determined.

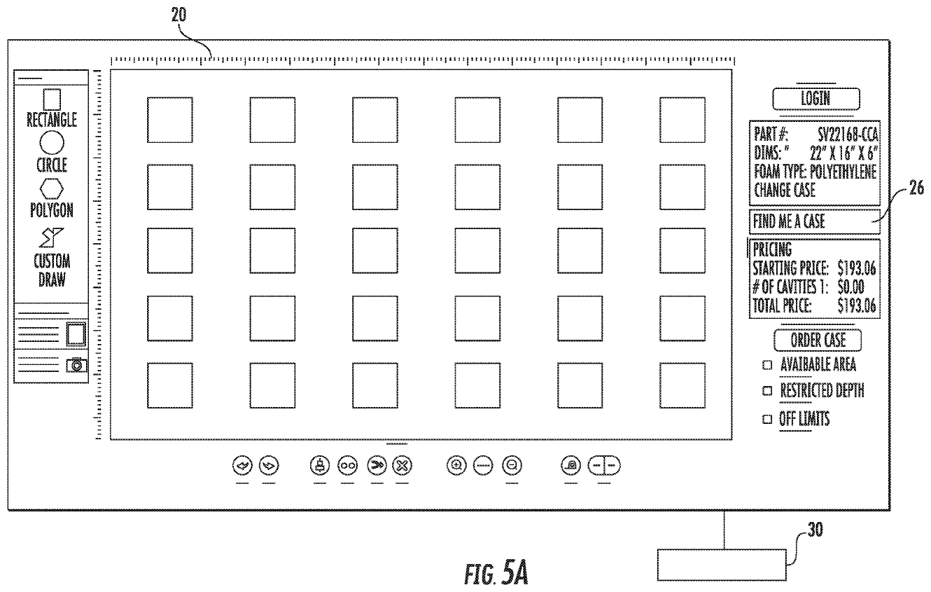

Alternatively, find me a container icon 26 as shown in FIG. 5A can be selected at design tool graphical user interface 20. Find me a container icon 26 can be activated to display new design user interface 39 as shown in FIG. 5B to display one or more containers or packages 46 having a predetermined size in relation to graphical common objects 44 as shown in FIG. 4. For example, one or more containers or packages 46 can be displayed having a predetermined size of up to four inches larger in each dimensions to graphical common objects 44. A container or package 46 can be selected by the user with graphical user interface 40. Graphical representation of a selected container or package and insert 27 can be displayed at display 24 as shown in FIG. 3.

Referring to FIG. 4, size graphical user interface 40 can display template 47 to instruct a user to enter known dimensions. A length dimension can be entered in interface box 50. A width dimension can be entered in interface box 52. A height dimension can be entered in interface box 54. After entering the dimensions, a user can select the entered dimension using user select box 55. From the selected dimensions, a size of starting canvas 23 can be determined. Perimeter 28 can be added to starting canvas 23 as shown in FIG. 3.

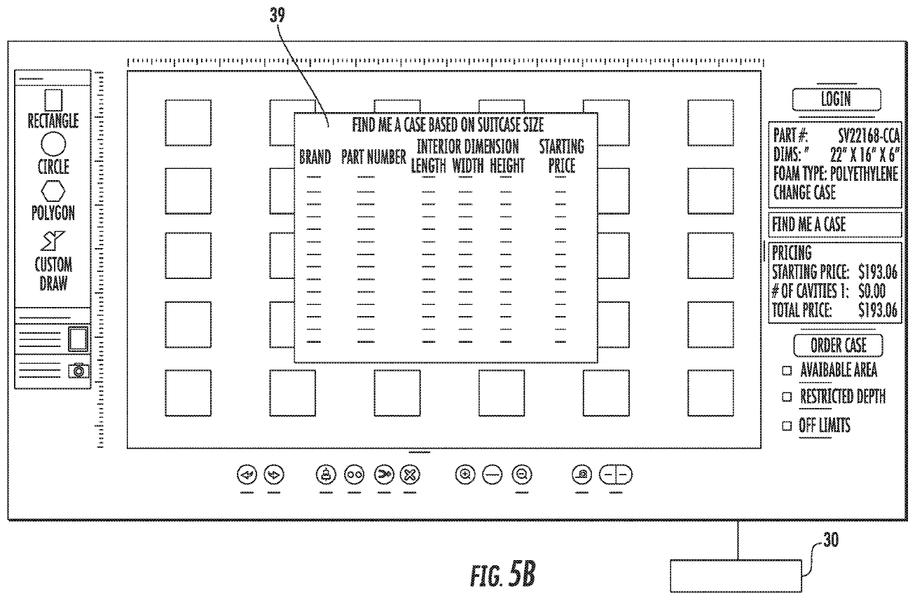

Referring to FIG. 1, in block 14 a design of a custom foam insert to be used in the container or package can be determined. In block 15, a foam type can be optionally selected. Design tool 30 designates a default foam type. For example, the default foam type can be polyethylene. Foam type icon 29 can be displayed on design tool graphical user interface 20 as shown in FIG. 6. Optionally, foam type icon 29 can be activated to select a foam type at any time. Activating of foam type icon 29 can launch pop-up foam type window 32 displaying a plurality of foam types 33a-33n which can be selected by a user. Corresponding comparison chart templates 34a-34n can be displayed which describe features of the foam types.

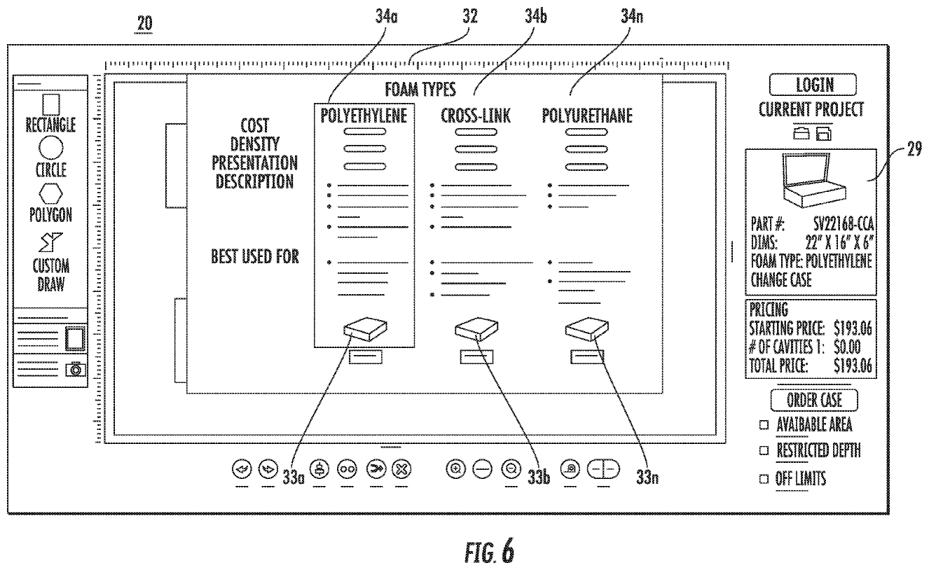

In one embodiment to implement block 14, insert shape graphical user interface 60 can be displayed on display device 24 as shown in FIG. 7. Shape selection toolbox 62 can display one or more shapes 63. After one or more shapes 63 are selected, shapes 63a-63n can be evenly spaced from left most shape 63a to right most shape 63n. A user places each of the shapes 63a-63n on starting canvas 23 then positions one shape 63a to the left most point they want then moves another shape 63n to the right most point they want. Once establishing the distance between first and last shape, the user can select space evenly icon 64 which automatically places the same distance D1 on starting canvas 23 between each shape 63a-63n.

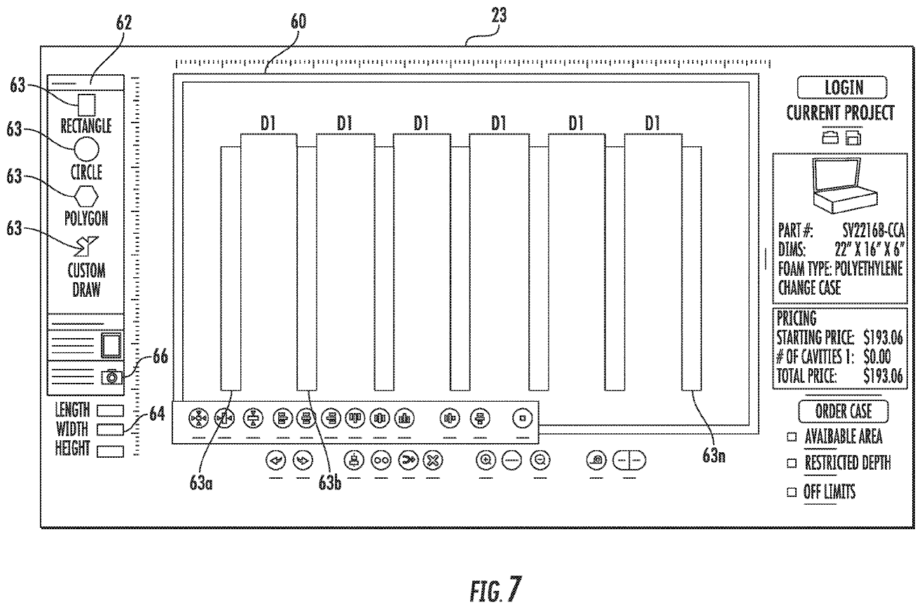

In one embodiment, photo trace icon 66 displayed on insert shape graphical user interface 60 can be used to design the custom foam to be used in the container or package. After photo trace icon 66 is activated, a user can take a photo of object 67 and then upload it in photo trace window 65 as shown in FIG. 8.

Photo trace design tool 70 can be used to determine that photo of object 67 meets specific guidelines, for example photo of object 67 includes a contrast background color and photo of object 67 has a predetermined format, such as for example jpg, jpeg, png, and gif.

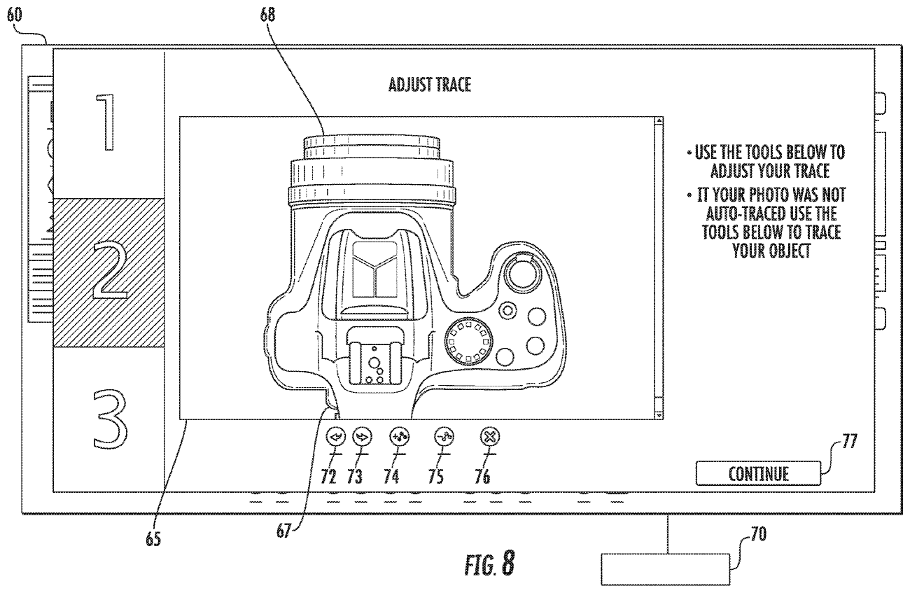

FIG. 9. is a flow diagram 80 of steps that can be used by photo trace design tool 70 to auto trace the part in photo of object 67 and save the trace to a user's private library. Photo trace design tool 70 can converts a bitmap to vector graphics. In one embodiment, photo trace design tool 70 is developed using SVG-edit. SVG-edit is a web-based, JavaScript-driven SVG drawing editor that works in most browsers.

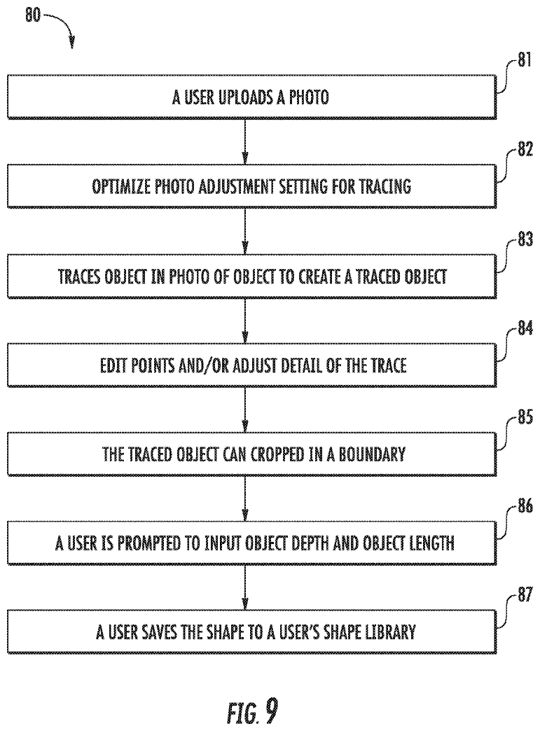

In block 81, a user uploads a photo. In block 82, photo trace design tool 70 runs a command to optimize photo adjustment settings for tracing. In block 83, photo trace design tool 70 traces object 68 in photo of object 67 as shown in FIG. 8 to create traced object 69 as shown in FIG. 10. Referring to FIG. 9, in block 84, a user can edit points and/or adjust detail of the trace add or remove points from the trace by activating respectively one or more of undo icon 72, redo icon 73, add point 74, delete point 75 and clear path 76 as shown in FIG. 8. After the trace is complete, the user can activate continue icon 77 to generate traced object 69 as shown in FIG. 10.

Referring to FIG. 9, in block 85 the traced object can be cropped in a boundary which is used for size ratio formatting. In one embodiment, traced object 69 can be cropped by rectangle boundary 79 as shown in FIG. 10 allowing object 69 to be imported in graphical user interface 20 in the objects actual size and proportion.

Referring to FIG. 9, in block 86 a user is prompted to input object depth and object length. Template 90 generated by photo trace design tool 70 can provide a prompt to input object depth and object length as shown in FIG. 10. Depth can be entered in template box 92 and length can be entered in template box 93. The depth is the distance the cavity goes into the foam. The length is the object's left most point to the right most point. The depth and length measurements can be used to scale traced object 69.

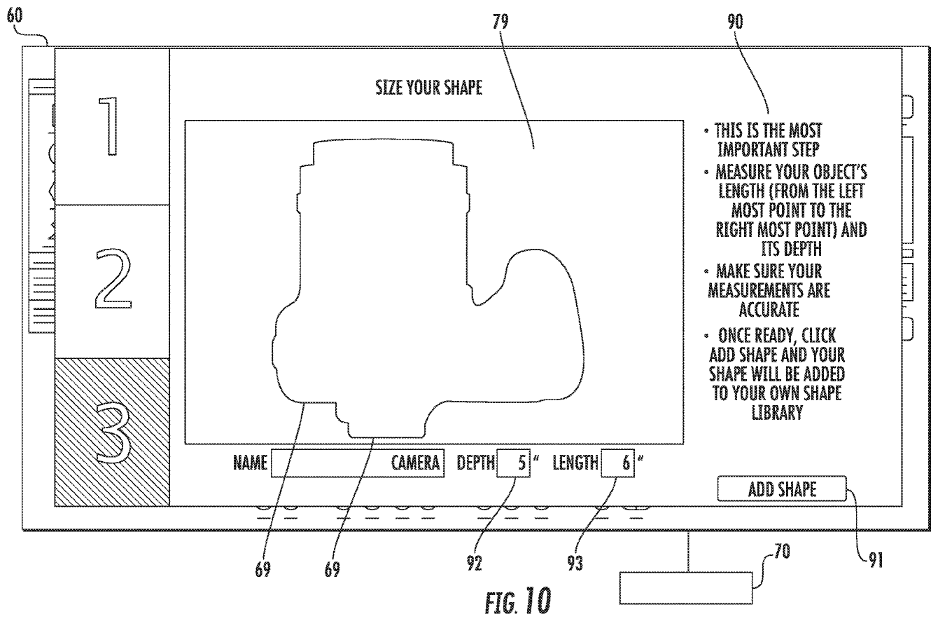

Referring to FIG. 9, in block 87 a user can save the shape to a user's shape library. In one embodiment, add shape icon 91 as shown in FIG. 10 is activated to save icon 94 showing traced object 69 to a user's shape library 95 as shown in FIG. 11. The shapes stored in user's shape library 95 are accessible to a specific user when logged into design tool 30. In addition, shapes can also be manually stored in user's shape library 95 by an administrator.

My shape library icon 100 can be displayed on graphical user interface 20 as shown in FIG. 11. A user can activate my shape library icon 100 to retrieve one or more of shapes which were previously stored user's shape library 95.

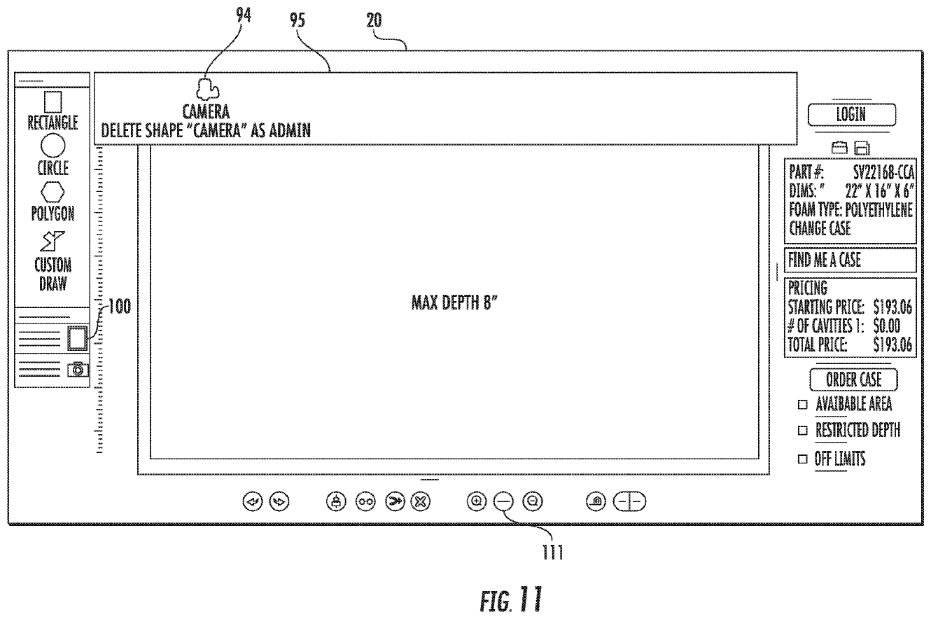

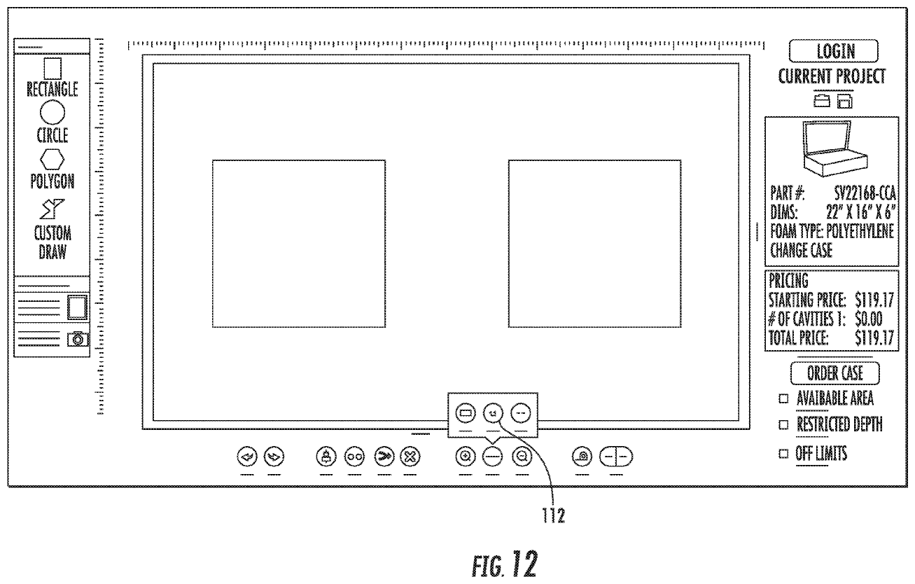

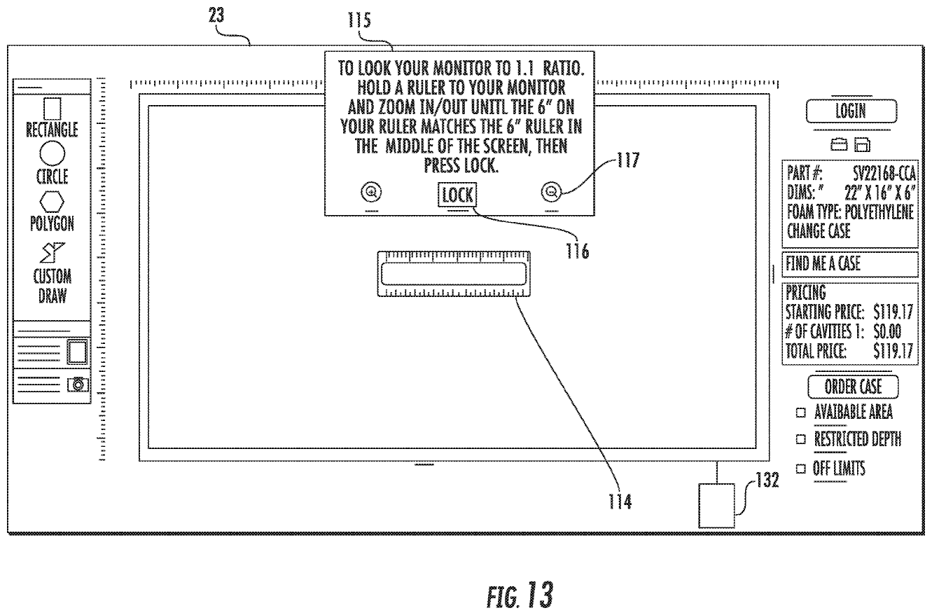

A user can activate icon 110 as shown in FIG. 11 to activate zoom actual icon 112 as shown in FIG. 12 to lock starting canvas 23 of graphical user interface 60 to a pre-determined value. In one embodiment, zoom lock icon 116 is activated to lock starting canvas 23 into a 1:1 ratio, such that 1 inch on canvas 23 is 1 inch as shown in FIG. 13. Screen ruler icon 114 can be used with starting canvas 23. Zoom template 115 can indicate directions such as, “To lock your monitor to 1:1 ratio hold a ruler to your monitor and zoom in/out until the 6″ on your ruler matches the 6″ on the middle of the screen. Then press Lock.” Zoom lock icon 116 can be used to lock starting canvas 23 after screen ruler icon 114 has been activated to determine the ratio of the canvas. In this embodiment, once locked after activating zoom lock icon 116, starting canvas 22 will be in the predetermined ratio, such as a 1:1 ratio, unless switch zoom options icon 117 is activated. If a user accidentally scrolls mouse 132, a user leave template window 118 as shown in FIG. 14 can be displayed indicating for example, “if you would like to leave Zoom Actual mode”. If a user leaves the zoom actual mode, the user can return to setting any time during current session by activating zoom actual icon 112 as shown in FIG. 12 and the user does not need to recalibrate.

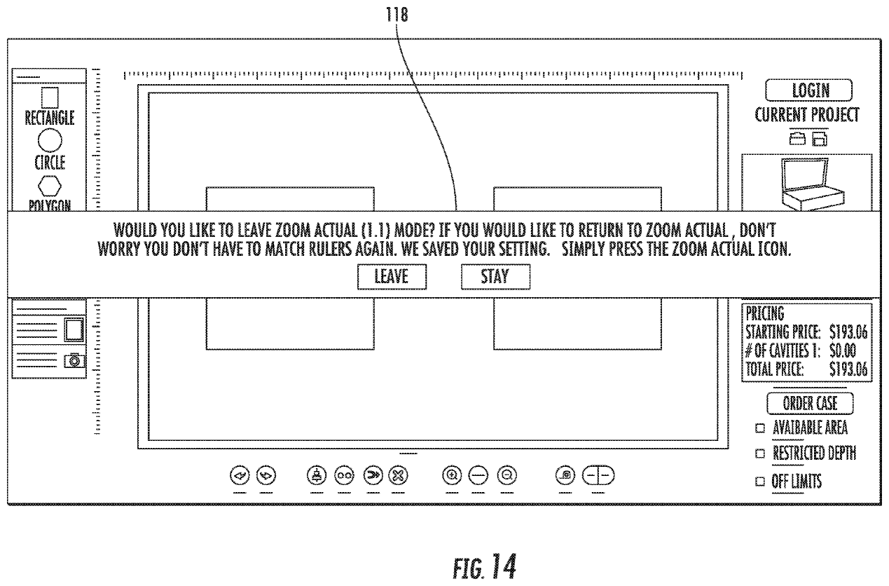

Referring to FIG. 15, photo trace design tool 70 can move a selected shape 63a-63n placed into off limits area 120 or border area 21 back onto starting canvas 23. For example, if a user moves a shape into off limits area 120 and then releases mouse 132 shape 63a-63n will automatically bounce back into canvas 23.

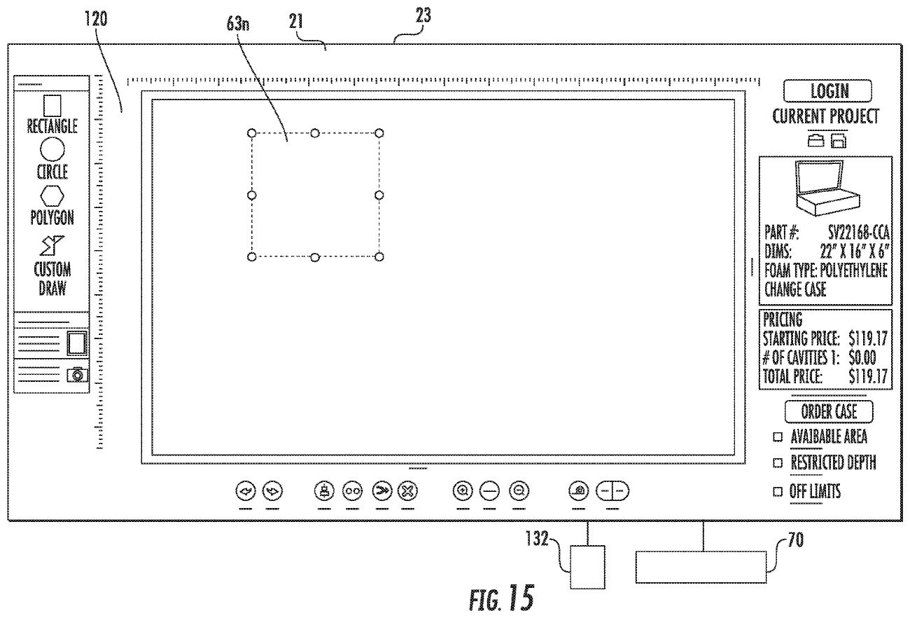

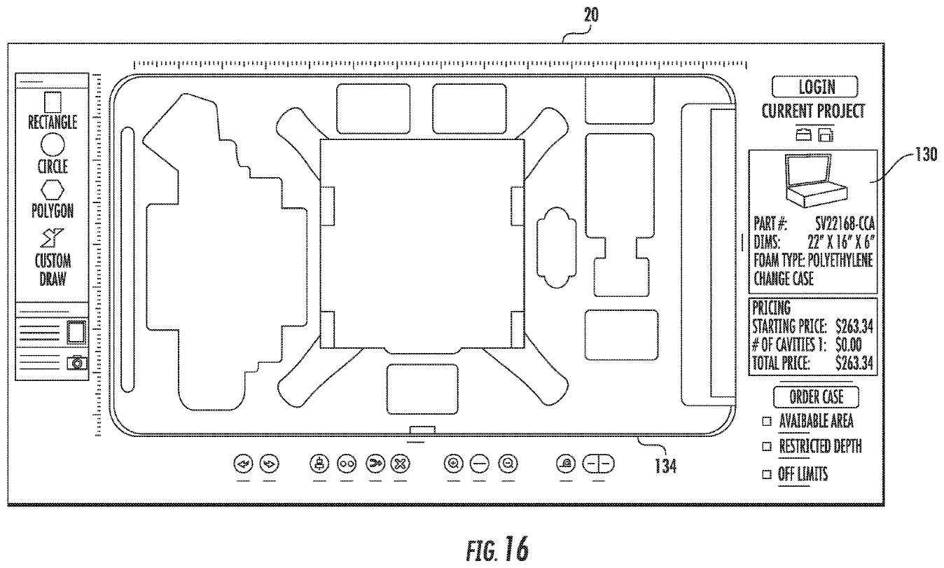

In one embodiment, a design of a custom foam can be used with a conventional container or package as shown in FIG. 16. A container or package is selected using container or package selection icon 130 at design tool graphical user interface 20. Add custom foam icon 132 can be activated as shown in FIG. 17 to modify the design of custom foam 134 displayed on display 24.

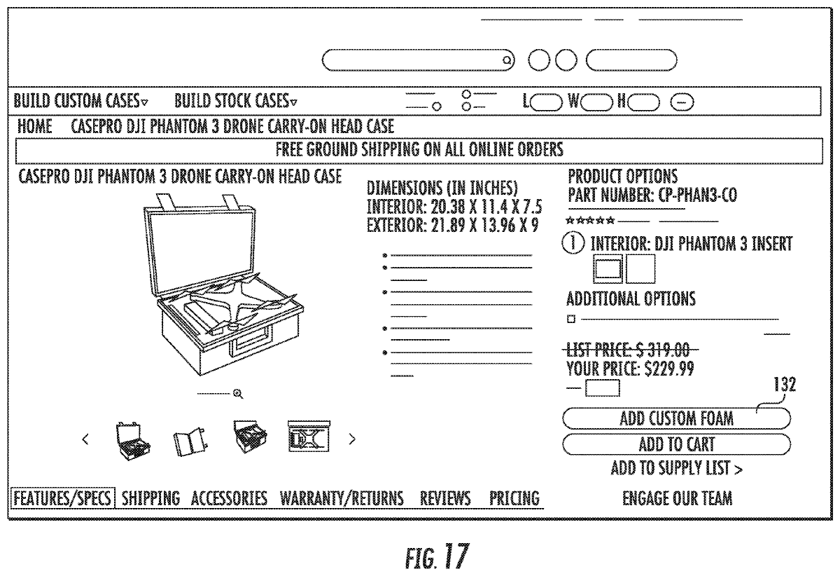

Referring to FIG. 18, design tool graphical user interface 20 can provide metric to imperial toggle icon 135. Activation of metric to imperial toggle icon 135 allows a user to switch between metric and imperial measurement standards in real time during the implementation of the method for custom designed container package and insert 10.

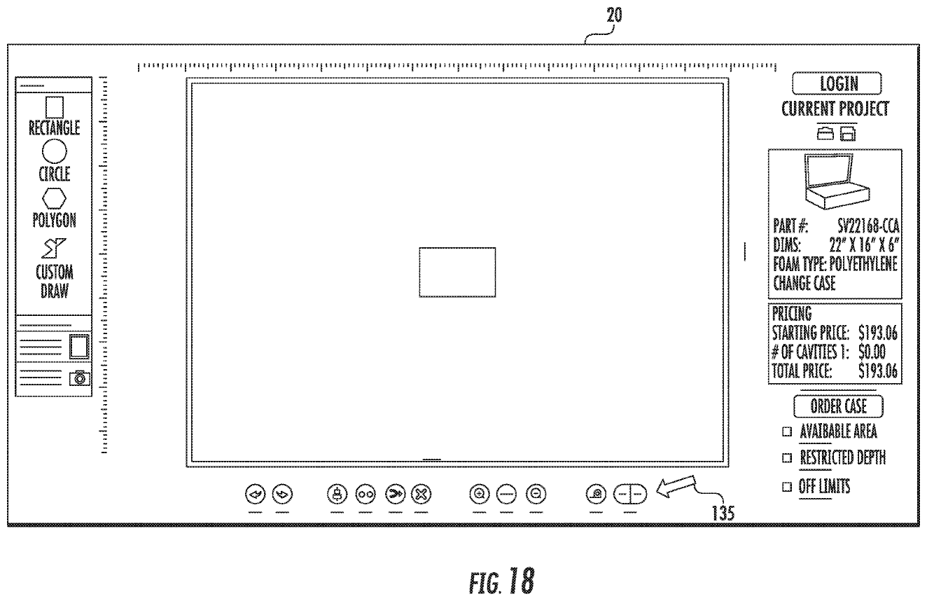

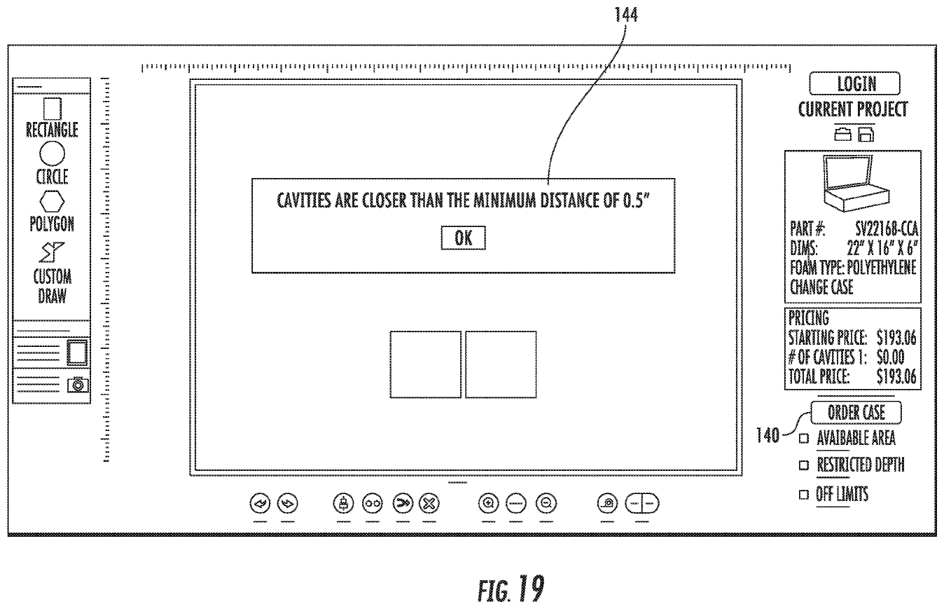

Photo trace design tool 70 of FIG. 9 can provide validation rules to provide parameters for manufacturing the custom designed container package and insert. Referring to FIG. 19, save or order case icon 140 can be activated for executing validation rules and sending a designed container package and insert to a shopping cart if the validation rules are met. Example validation rules include making sure a user does not create shapes deeper than foam, moving shapes in off limit areas 120 and border area 121 and moving shapes 63a-63n too close to each other. The rule of moving shapes 63a-63n too close to one another can be implemented by setting a minimum distance rule for spacing shapes. The minimum distance is dependent on the length of custom designed container or package and material of the insert. In one embodiment, if a user inputs shape dimension which does not fit within case dimensions the user will not be allowed to add or edit shape. When user clicks add cavity icon 143 as shown in Fig. and number is in violation, an error message will display telling user “Value must be less than ______” in template 144. For example, the validation rules can be is defined in a SVG file. When a user places shapes too close to each other and the user tries to Save/Order Case they will see an error message display. Design tool 30 can also add a colored border around shapes that are in violation as shown in FIG. 19.

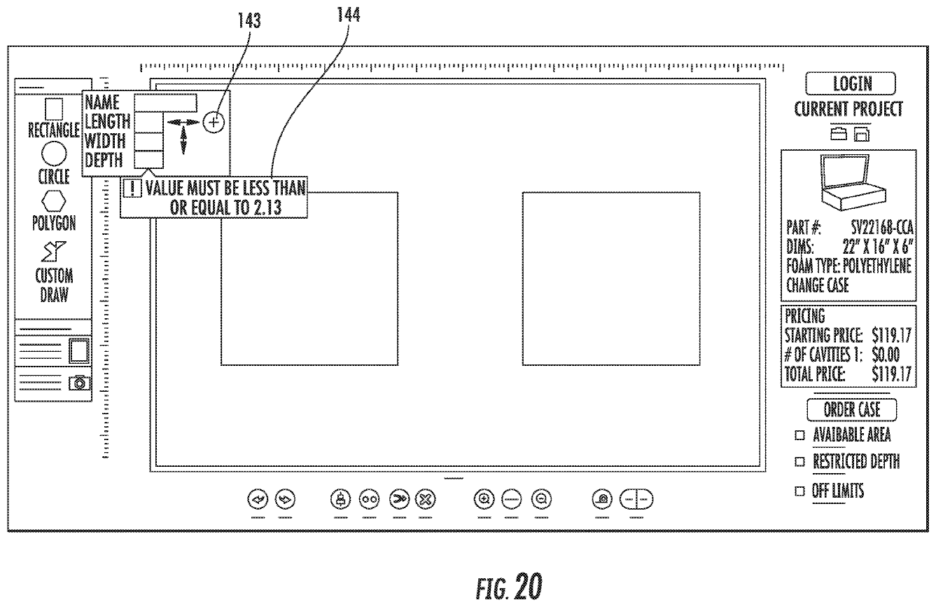

Referring to FIG. 21, design tool 30 can provide a dynamic pricing model. Pricing of container icon 150 can be displayed on design tool graphical user interface 20. Activating pricing of container icon 150 can display pricing template 151 on display 21. Pricing template 151 can display parameters for determining pricing.

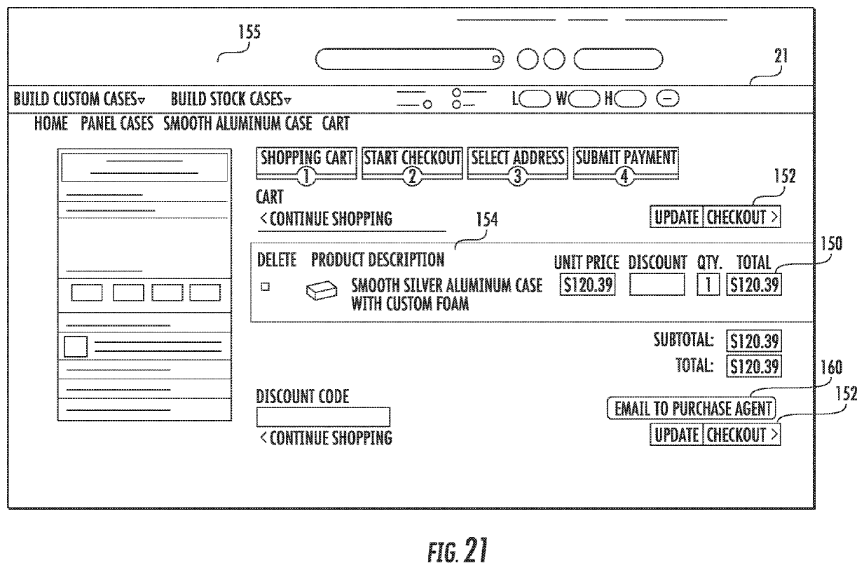

A user can activate an order case icon 152 and an order for a container or package and custom foam insert 154 is sent to shopping cart 155. A user receives an order confirmation email 157 with an attachment of the custom container and foam design 158 as shown in FIG. 22.

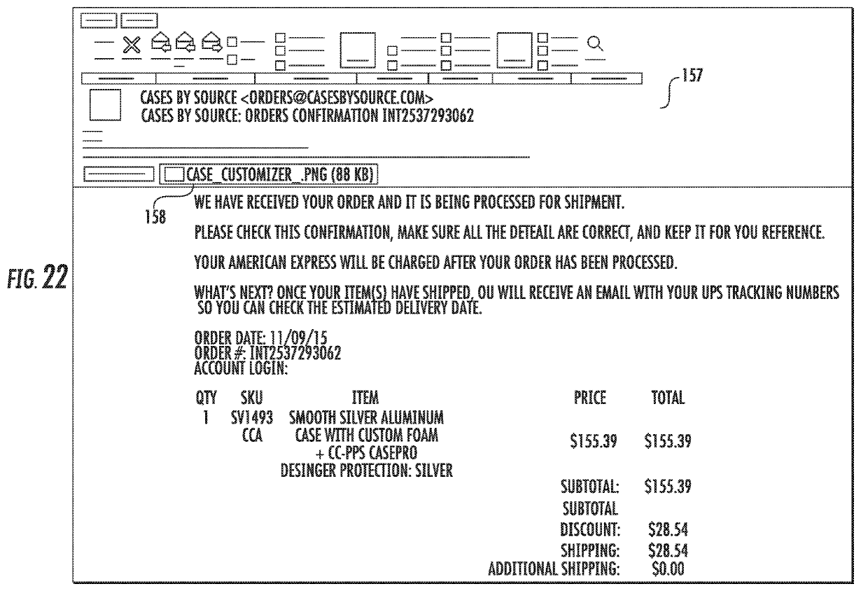

Alternatively, a forward design in a shopping cart icon 160 as shown in FIG. 21 can be activated to forward an order for the container or package and custom foam 154 in the shopping cart 155 to another entity. In one embodiment, a container and custom foam design email 162 as shown in FIG. 23 is sent including an order for the container or package and custom foam design 154.

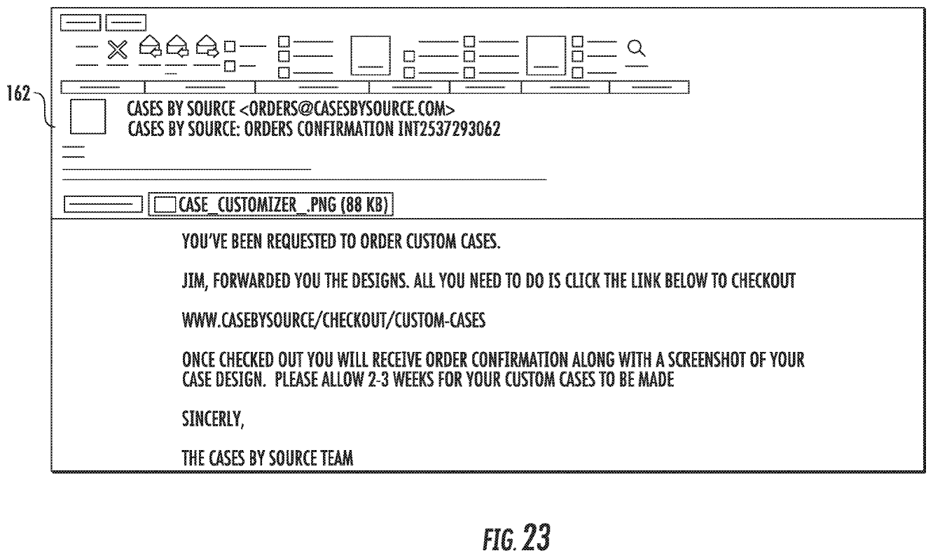

FIG. 24 is a schematic diagram of hardware and/or electronics that can make up custom designed container package and insert system 200. One or more communications mediums 201 such as a bus or network interconnect the illustrated components and allow data and/or signals to flow between the components. CPU 202 is a processor that performs calculations and logic operations required to execute a program. Any number of processors may be available, and they may access a computer-readable memory device 203 containing programming instructions, along with a data storage facility 204 such as a database that stores generated images, templates and/or rule sets in a computer storage medium. Memory 203 and data storage may comprise electronic storage media that electronically stores information. The electronic storage media of electronic storage may include one or both of system storage that is provided integrally (i.e., substantially non-removable) with processor 202 and/or removable storage that is removably connectable to processor 202 via, for example, a port (e.g., a USB port, a firewire port, etc.) or a drive (e.g., a disk drive, etc.). Electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage may include one or more virtual storage resources (e.g., cloud storage, a virtual private network, and/or other virtual storage resources). Electronic storage may store software algorithms, information determined by processor 202 information received at processor 204 and/or other information that enables processor 202 to function as described herein.

Processor(s) 202 may include one or more of a digital processor, an analog processor, a digital circuit designed to process information, an analog circuit designed to process information, a state machine, and/or other mechanisms for electronically processing information. Although processor 202 is shown in FIG. 24 as a single entity, this is for illustrative purposes only. In some implementations, processor 202 may include a plurality of processing units.

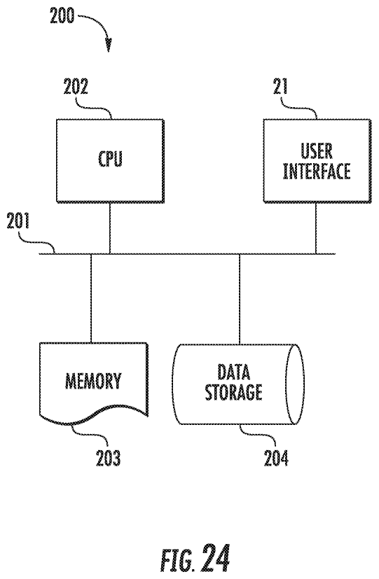

Referring to FIG. 25, another embodiment of the present invention is a system 300 including a web server 312 having a processor 314 and a website 316. The processor 314 implements the system 300 and method 500, as described below, using a computer programming language, such as JAVASCRIPT and ANGULARJS, which is a JAVASCRIPT-based open-source front-end web framework. The system 300 further includes a user computer 318 which interacts with the web server 312 through a network 320, such as the Internet and/or other known communication networks. In one embodiment, the system 300 implements a web-based application for creating custom packaging, such as custom road cases, with no application program installation and no file downloading. Only webpage access of the user computer 318 to the website 316 is required. The system 300 implements, for example, a road case designer which enables users to select a case style, design a custom road case, and then submit an online order to manufacture the custom road case using the manufacturing system 330, and to have the manufactured custom road case delivered to the user.

Through the network 320, the web server 312 and the user computer 318 interacts with a database 322 and a manufacturing system 330 to design and manufacture a container, package, and/or an outer case, as well as to design and manufacture a custom foam insert which fits into the outer case and which is adapted to receive objects, as described herein. Accordingly, the system 300 is an efficient alternative to the costly service of professional engineered solutions to packaging and road case manufacturing, and the system 300 offers a user-friendly web-based application that gives the user the abilities of computer-aided designing and manufacturing. Using the system 300, users can select dimensions of packaging, add wheels, change colors, and design and manufacture a custom foam interior using the manufacturing system 330.

The user computer 318 has an input/output device 324, a processor 326, and a memory 328 for displaying at least one interface to a user through the input/output device 324, for receiving and processing inputs through the input/output device 324, and for communicating through the network 320 to the various components 312, 314, 316, 322, 330 of the system 300. For example, the user computer 318 displays the at least one interface for viewing the website 316.

In one embodiment, the system 300 implements the method 10 as shown in FIG. 1, including the steps of triggering entry into a graphical user interface (GUI) in step 11; selecting a size of a package using a size GUI displayed on a display device, such as the input/output device 324, in step 12, using an insert shape GUI displayed on the display device to design a custom foam insert in step 14; optionally selecting a foam type of the custom foam insert in step 15; creating a representation of the designed custom foam insert and packaging in step 16; displaying the representation on a display such as the display device in step 17; saving the representation in a memory as a data file in step 18; and transmitting the representation to a communications device associated with a merchant, vendor, or provider of a good, a product or a service, such as to the manufacturing system 330 to manufacture the designed custom foam insert and packaging, in step 19.

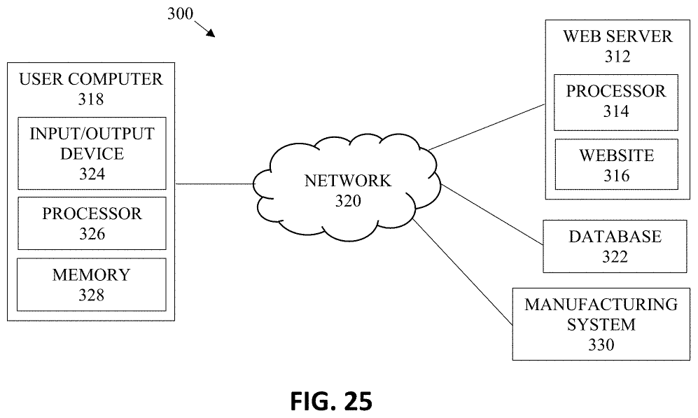

In a further embodiment, the system 300 implements the method 400 as shown in FIG. 26, including the steps of triggering entry into a graphical user interface (GUI) in step 411; selecting a size of a package using a size GUI displayed on a display device, such as the input/output device 324, in step 412, using an insert shape GUI displayed on the display device to design a custom foam insert in step 414; optionally selecting a foam type of the custom foam insert in step 415; creating a representation of the designed custom foam insert and packaging in step 416; displaying the representation on a display such as the display device in step 417; saving the representation in a memory as a data file in step 418; and manufacturing the designed custom foam insert and packaging, using the representation supplied to the manufacturing system 330, in step 419. The step 418 of saving the representation in a memory as a data file may include saving the representation as a DXF file, as described below.

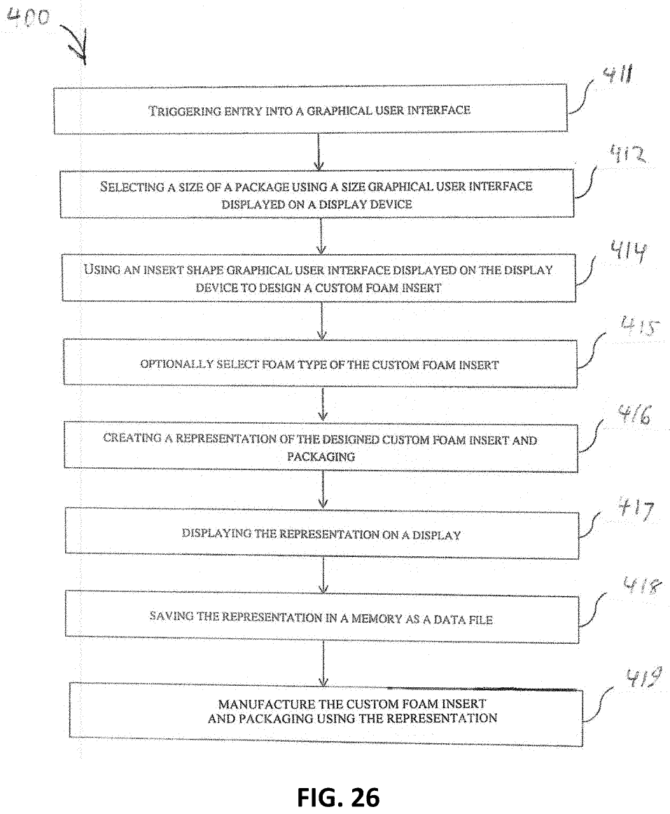

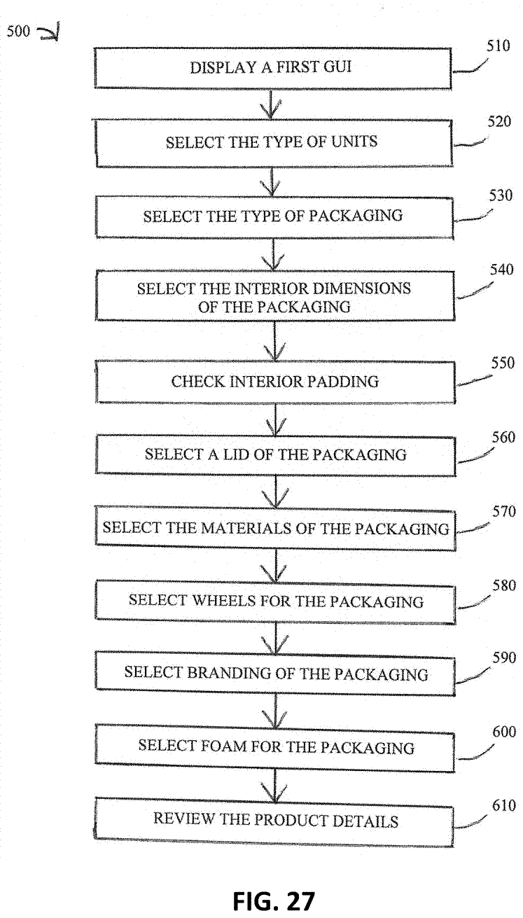

In an alternative embodiment, as shown in FIG. 27, the system 300 performs the method 500 of creating a packaging, also referred to as a package, a container, a case, or an outer case, in which the custom foam insert, described above, is disposed to retain objects. The method 500 includes the step of displaying a first GUI in step 510, such as the GUI 512 in FIG. 28. A progress bar may optionally be displayed on successive GUIs, indicating which stage in the packaging creation process that the user is currently situated, as shown in FIGS. 28-31. Once the user has completed all selections at a given stage in the progress bar, the user actuates or clicks a NEXT icon displayed on the respective GUI so that the system 300 proceeds to a next stage, which may be a next step in the method 500 in FIG. 27.

At every stage in the progress bar as well as every step in which the user changes a value, such as the dimensions, the system 300, using the processor 314 and accessing parts and pricing data in the database 322, updates a price 526 in real-time as displayed on the GUIs shown in FIGS. 28-31. In this manner, the user can determine the price 526 with all of the selected features up to that point, and can decide whether to change some of the selected features, such as to specify a smaller packaging to reduce the overall cost of the packaging to be manufactured by the manufacturing system 330. Such real-time price updates allow for a better user experience as the user can see the price of the packaging update as the user makes each configuration selection. Using accurate pricing data stored in the database 322, the system 300 determines the true cost to manufacture the custom packaging using the manufacturing system 330. Accordingly, as the user designs the packaging, the cost updates which results in the changing of the price and cost to the user.

The method 500 then proceeds to the step of selecting the type of packaging under the CASE stage, such as a road case composed of plywood sides, top, and bottom, and with metallic re-enforced edges and corners, otherwise known as a roadie case, a flight case, an Air Transport Association (ATA) case, or an Airlines for America (A4A) case. The road case may be a top-loading road case in which the lid hinges or is removable from the top. Another case style option is a side door road case which, when selected by the user, causes the software application to launch and default to showing a side door configuration. Additional types of cases from which the user will have a choice include a trunk case, a suitcase, a reverse lid case, a side door case, a nineteen inch rack case, etc. Other types of cases include a simple container with, for example, plastic sides, or a corrugated box. After the type of case is selected, the user can then select the material for the case, such as acrylonitrile butadiene styrene (ABS) plastic, plywood, plastic composite board, fiberglass composite, and combinations thereof. The selected type of packaging is then indicated by a notation 528 displayed on the GUIs shown in FIGS. 28-31. Once the user has completed the selection of the type of packaging in step 530 in FIG. 27, the user actuates or clicks a NEXT icon displayed on the respective GUI so that the system 300 proceeds to a next stage.

The method 500 then proceeds to the step of selecting the type of units in step 520, such as using a drop-down menu 522 to select either imperial or metric units associated with the dimensions of the packaging; and selecting the type of packaging, such as a ready-made packaging or a do-it-yourself (DIY) packaging, in step 530 using the drop-down menu 524. Selection of ready-made packaging or DIY packaging causes the processor 314 to automatically update the displayed price 526, as described above. A ready-made packaging is a customized packaging which is completely built by the manufacturing system 330 as a single unit for delivery to the user. A DIY packaging is a set of distinct and separate components such as the panels, extrusions, handles, corners, hardware, etc. which, when delivered to the user, allows the user to build the packaging. DIY packaging may be priced less than the ready-made packaging by being of less cost in assembling and shipping the separate components. For example, separate components of a DIY packaging may be shipped relatively flat, which saves the customer in shipping costs.

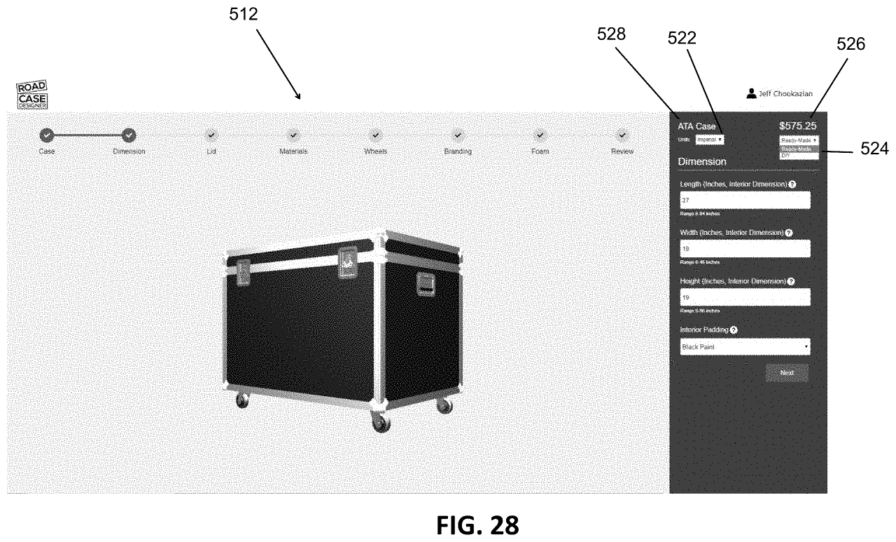

The method 500 then includes the step 540 of selecting the interior dimensions of the packaging, for example, using input fields 544 and/or drop-down menus in a second GUI 542, as shown in FIG. 29, for inputting the interior dimensions of the packaging such as length, width, and height, as described in further detail in connection with steps 12 and 412, discussed above. The second GUI 542 may also display a drop-down menu 546 for selecting the interior padding, such as “1 inch Ester (soft foam)”, “2 inch Ester (soft foam)”, “1 inch PE (hard foam)” composed of polyethylene (PE), “2 inch PE (hard foam)” carpet lined, and “Black Paint” which is an option having the inside plywood being painted black to disguise any nuts and bolts of the hardware, such as the handles and latches. Another option for the interior padding is “Raw Finish”, in which the plywood is in a natural, unpainted state with no extra finish. Once the user has completed the selection of the interior dimensions in step 540 in FIG. 27, the user actuates or clicks a NEXT icon displayed on the respective GUI so that the system 300 proceeds to a next stage.

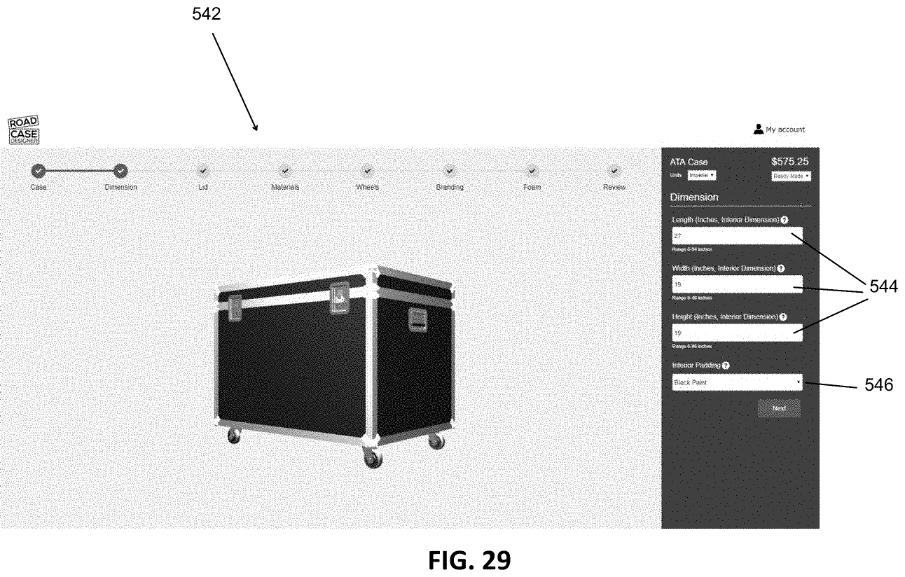

The processor 314 of the web server 312 performing the method 500 then checks the dimensions of the interior padding in step 550 using a predetermined algorithm, and generates an alert with a message, such as the interior dimension update pop-up window 552 overlaying the GUI 542, as shown in FIG. 30, indicating that the dimensions of the interior padding in relation to the cavity formed by the interior dimensions of the packaging. For example, for a 1 inch Ester soft foam padding and interior dimensions of 25 in×17 in×17 in, the predetermined algorithm adds one inch to every side, or two inches to every dimension, such that the overall size of the packaging would be 27 in×19 in×19 in to accommodate the interior padding. The processor 314 generates an alert to the user to confirm that the desired packaging is to be 27 in×19 in×19 in by actuating or clicking an OK icon, or otherwise to actuate or click on a REVERT or CHANGE icon to modify the interior dimensions of the packaging, by returning to the GUI 542 in FIG. 29. Such alerts to the user improve the user experience during the design process and before the manufacturing process by the manufacturing system 330, so that the user receives a packaging with cavity dimensions as expected by the user. The GUI 542 may also include an explanation icon which, when selected by the user by clicking, causes the processor 314 to present to the user the interior dimension update pop-up window 552.

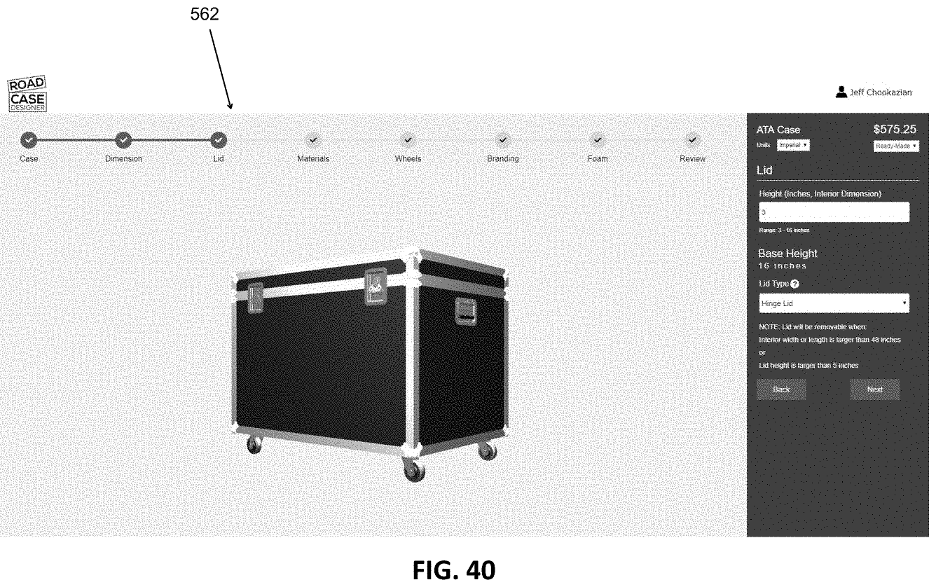

The method then includes selecting a lid in step 560, in which a GUI 562, shown in FIG. 40, is displayed with an input field and/or a drop-down menu allowing the user to specify the size of the lid, which may range from 3 in to 12 in. As the size of the lid is selected, an indicator in the GUI 562 displays the base height of the lower portion of the packaging, with the base height being determined by the processor 314 to be the interior height minus the lid size. The GUI 562 also includes a drop-down menu for selecting the lid type, such as a hinged lid or a non-hinged, removable lid. The processor 314 may force the selection of the lid to be removable if a predetermined condition is met, such as when the interior length or width is greater than 48 in and/or when the lid height is larger than 5 in. Once the user has completed the selection of the lid in step 560 in FIG. 27, the user actuates or clicks a NEXT icon displayed on the respective GUI 562 so that the system 300 proceeds to a next stage.

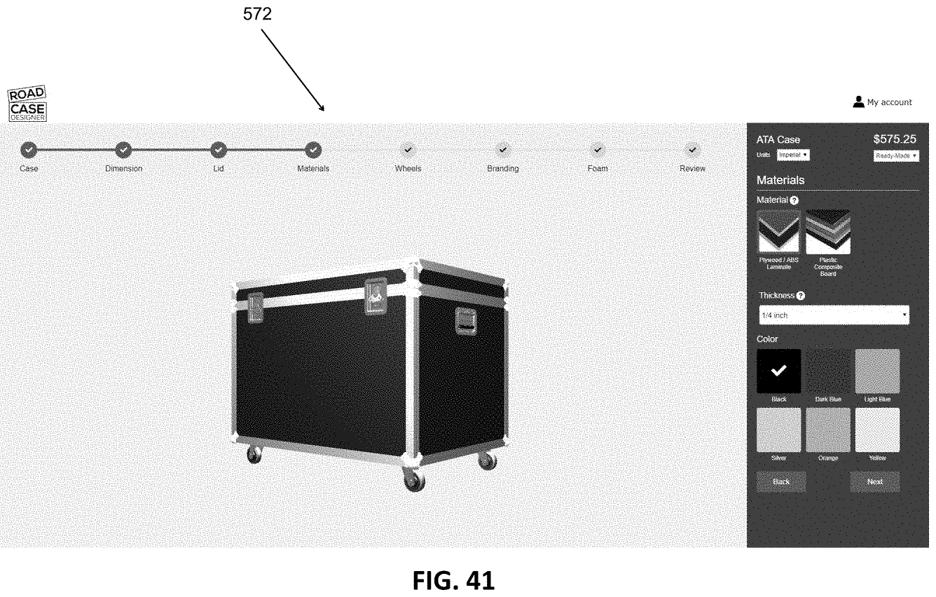

The method then includes selecting materials in step 570, by which a GUI 572, shown in FIG. 41, is displayed which allows the user to select the type, thickness, and color of the materials; that is, the color of the exposed surface of the materials forming the surfaces of the packaging. The GUI 572 employs actuatable/clickable icons, input fields and/or drop-down menus for receiving the user selection of the material type, thickness, and color. Once the user has completed the selection of the materials in step 570 in FIG. 27, the user actuates or clicks a NEXT icon displayed on the respective GUI 572 so that the system 300 proceeds to a next stage.

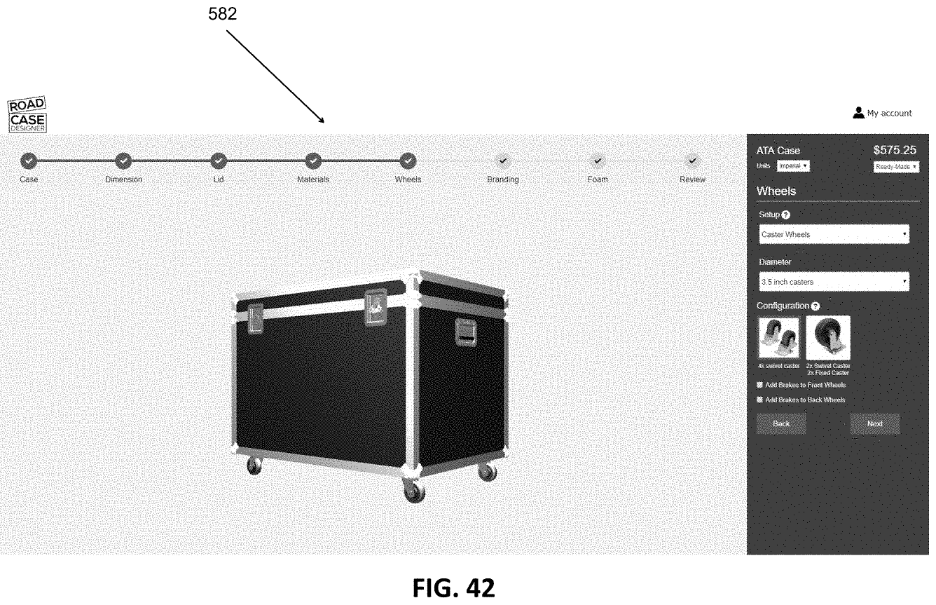

The method then includes selecting wheels in step 580, by which a GUI 582, shown in FIG. 42, is displayed which allows the user to select the setup, diameter, and configuration of the wheels, and whether and where brakes are included with the wheels. The setup selection allows the user to select the types of wheels, such as wheels with or without casters, or edge wheels having a handle. The diameter selection specifies whether the wheels are 3.5 in casters, 5 in casters, or 8 in tires. The configuration of the wheels specifies the packaging has four swivel casters for the wheels, or instead two swivel casters and two fixed casters. The brake selections specify that there are brakes on the front wheels and/or on the back wheels. The GUI 582 employs actuatable/clickable icons, radio buttons, check boxes, input fields and/or drop-down menus for receiving the user selection of the setup, diameter, and configuration of the wheels, and the brakes included with the wheels. Once the user has completed the selection of the wheels in step 580 in FIG. 27, the user actuates or clicks a NEXT icon displayed on the respective GUI 582 so that the system 300 proceeds to a next stage. At each step 560-580, the system 300 displays the various GUIs 562, 572, 582, respectively, as shown in FIGS. 40-42, generated for each step and having appropriate input fields and/or drop-down menus for receiving user inputs and selections.

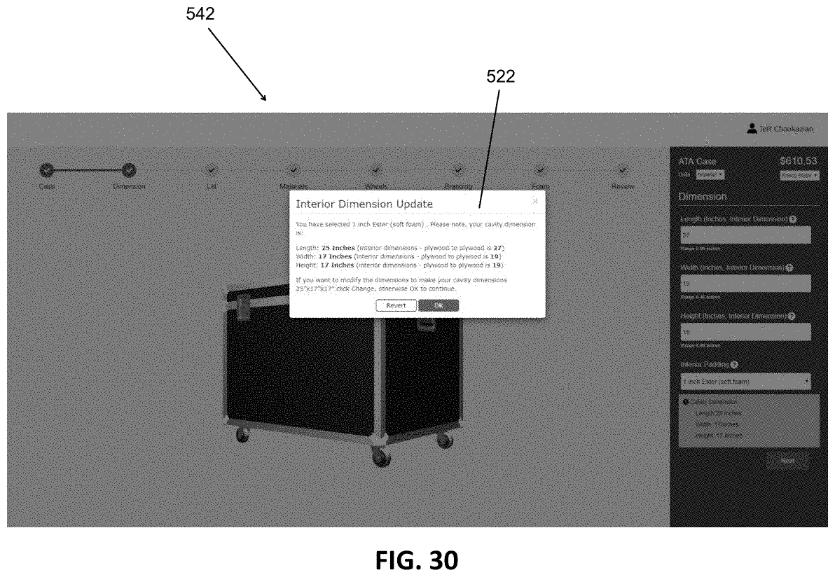

The method further includes selecting branding for the packaging in step 590, using a GUI 592 as shown in FIG. 31. The user can add a name, a brand name, a stencil, or any other text, identifiers, indicia and/or symbols using the input field 594. The user also can use a drop-down menu 596 to select the placement of the stencil as either on the front of the packaging, on the top, on the side, or on multiple locations such as front and top. The stencil may have a limit of, for example, fifteen characters and/or symbols. In addition, the stencil may be rendered on the three-dimensional (3D) image of the packaging displayed by the GUI 592; for example, the stencil may be rendered character-by-character in real-time as the user inputs the text characters and symbols. The automatic real-time rendering of the characters of the stencil improves the user experience in that the user can see what is being input in real-time instead of having to select a button or other updating mechanism to trigger an update in the rendering of the stencil. Alternatively, to improve processing and rendering performance, the stencil may be intentionally not rendered on the 3D image.

The user can select the color of the stencil, that is, by actuating or clicking on one of a selected color regions 598. In another embodiment, the processor 314 may determine that the color of the stencil, as ground, is the same as the color of the material, as background, and so the processor 314 may prevent the colors from being identical and/or the processor 314 may generate an alert message on the GUI 592 to inform the user of the sameness of the colors. For example, the text entered in the input field 594 may be “COMPANY ABC” using a default font and default size. In alternative embodiments, the user can specify the font and/or size of the stencil. If the user wishes to return to an earlier stage, the user actuates or clicks the BACK icon 599. Once the user has completed the selection of the branding in step 590 in FIG. 27, the user actuates or clicks a NEXT icon displayed on the respective GUI so that the system 300 proceeds to a next stage.

The method also includes selecting foam in step 600, in which the user designs and manufactures a custom foam insert as interior padding which specifically fits into the packaging which the user is designing. The custom designing and manufacturing of the foam insert is described in greater detail above. For example, using the methods and systems described above, the user has a two dimensional (2D) view from the top of the packaging into the base of the packaging. The user can add predefined shapes such as rectangles, circles, and polygons to a design canvas, as described above, and the user can input the dimensions of each added shape. The user also has the ability to custom draw or trace a shape by selecting the custom drawing tool, and drawing a path on the design canvas, and then inputting a depth of each shape, as described above. The shapes may be stored in a shape library in the database 322, and such shape libraries may be specialized for specific industries. For example, a shape library may be exclusively for storing shapes of musical instruments, such as a guitar or tambourine. Accordingly, the user can quickly access a specific shape library to create a custom foam insert for a guitar to be disposed in the custom foam insert and placed within an appropriate packaging or road case for shipping the guitar. Once the user has completed the selection of the foam in step 600 in FIG. 27, the user actuates or clicks a NEXT icon displayed on the respective GUI so that the system 300 proceeds to a next stage.

Throughout the steps 510-600 of the method 500, the packaging and its features and accessories, such as dimensions, wheels, and color, are rendered in 3D on the various GUIs as the creation of the packaging is updated in real-time and without having to select a button to trigger the update. Such 3D rendering in real-time of the packaging allows for a better user experience as the user can see the packaging created by the user which is automatically and immediately updated in 3D as the user makes each configuration selection.

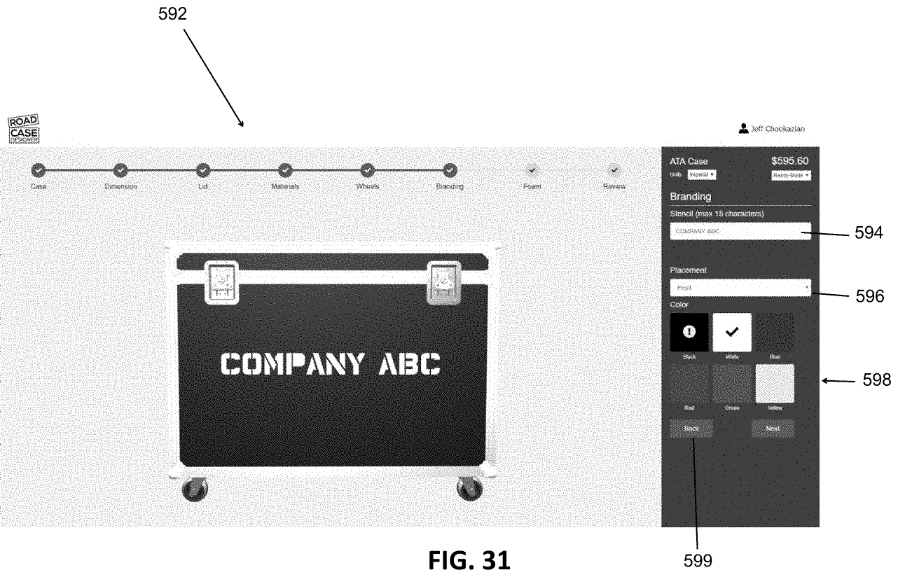

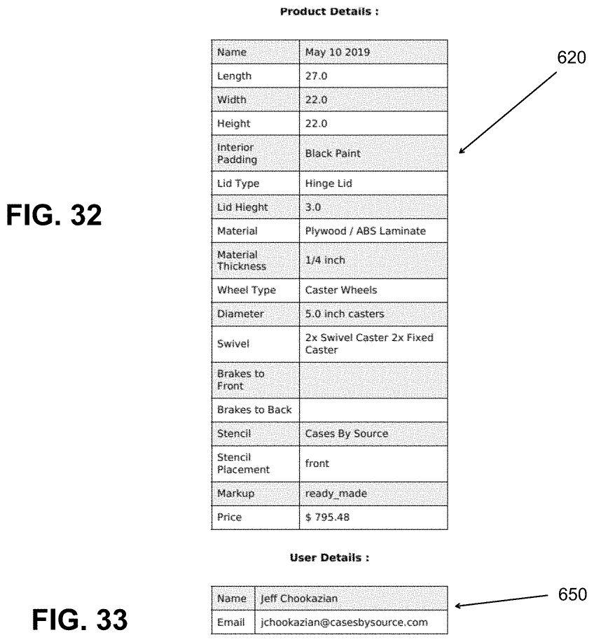

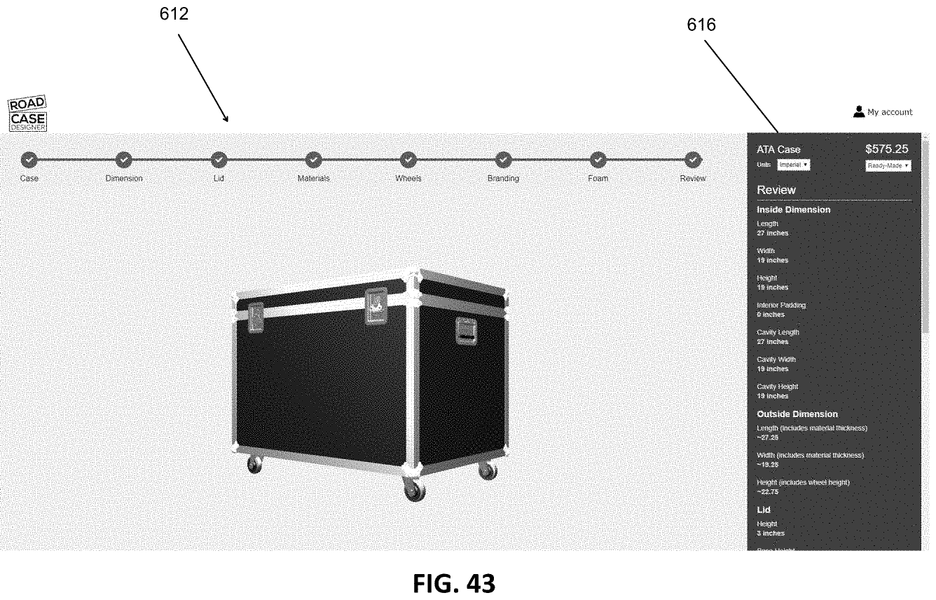

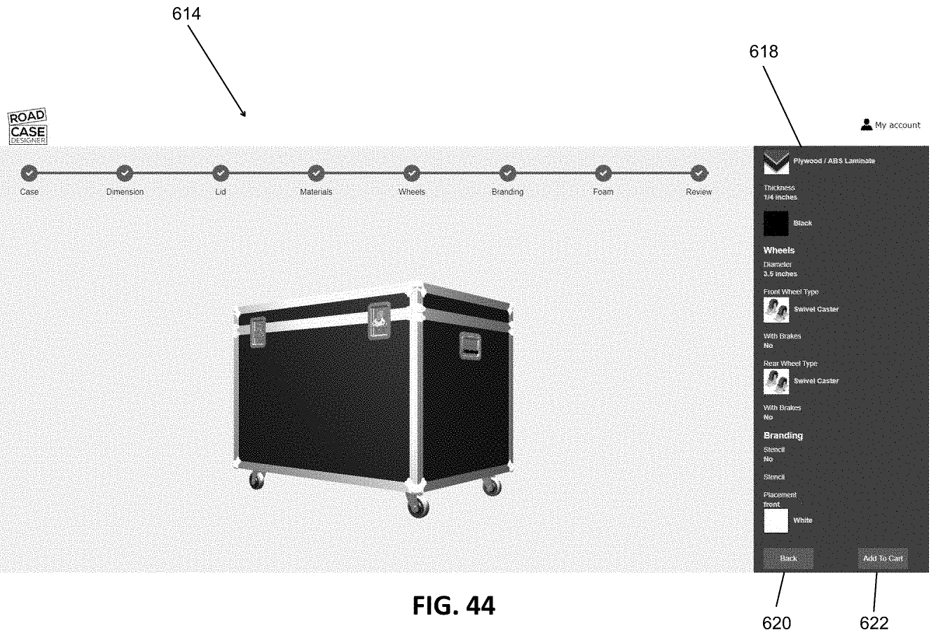

Finally, in step 610, the product details are displayed for review by the user in the GUIs 612, 614 shown in FIGS. 43-44, respectively. Once the user has completed the review of the product details of the customized packaging in step 610 in FIG. 27, the user actuates or clicks a NEXT icon displayed on the respective GUI so that the system 300 proceeds to manufacture the packaging, such as shown in step 419 in FIG. 26, using the manufacturing system 330; and/or to display a shopping cart screen so that the user can purchase the customized packaging. For example, a list 620 of the product details, as shown in FIG. 32, is displayed by the input/output device 324 via the website 316. The product details may include a text field specifying a name of the packaging, which may be any arbitrary text such as the date on which the packaging was created. User details 650, such as shown in FIG. 33, may also be displayed to indicate the user and contact information, such as an E-mail address, who is associated with the list 620 of product details of the created packaging.

Alternatively, the product details are displayed on a scrollable portion 616, 618, of the GUIs 612, 614 in FIGS. 43-44, respectively. An icon 620 labeled “Back” allows the user to return to an earlier stage such as the Foam stage and earlier stages to change any product details and settings. Another icon 622 labeled “Add To Cart” allows the user to accept the current product details and to purchase a corresponding product. Such a purchase may involve manufacturing of the corresponding product using the manufacturing system 330 and/or saving the representation of the customized packaging in a memory, as described above.

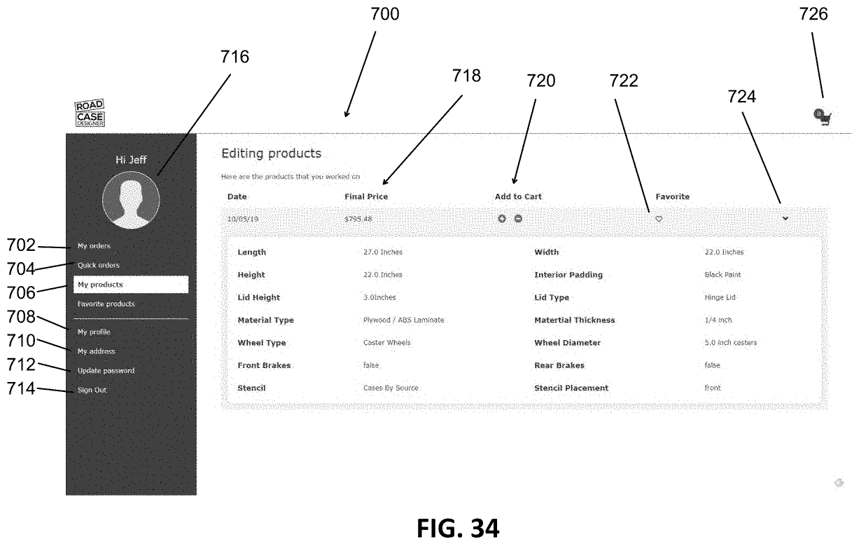

The system 300 of the present invention also manages the packaging as products for sale, with their prices managed such as the prices of parts, and performs administrative functions associated with users. FIG. 34 shows a profile screen 700 as a GUI listing packaging as products with product details, and associated with the user. The profile screen 700 may have icons for orders associated with the user, which is accessible by actuating or clicking the My Orders region 702 of the screen 700. Similarly, the user may actuate or click the Quick Orders region 704 to display any previous orders of the user, allowing the user to re-order and re-purchase a selected previously ordered case; a My Products region 706 for displaying packaging associated with the user; a My Profile region 708 for viewing and/or editing a profile of the user used by the system 300 and maintained in the database 322, with the profile including the name and other contact information of the user; a My Address region 710 for viewing and/or editing an address and other contact information such as the E-mail address of the user; an Update Password 712 for editing a password allowing a user to access the system 300; and a Sign Out region 714 for allowing the user to log out of the system 300. To personalize the profile of the user, a photo 716 of the user, along with the name of the user, may be stored in the database 322 and displayed on the profile screen 700, as shown in FIG. 34.

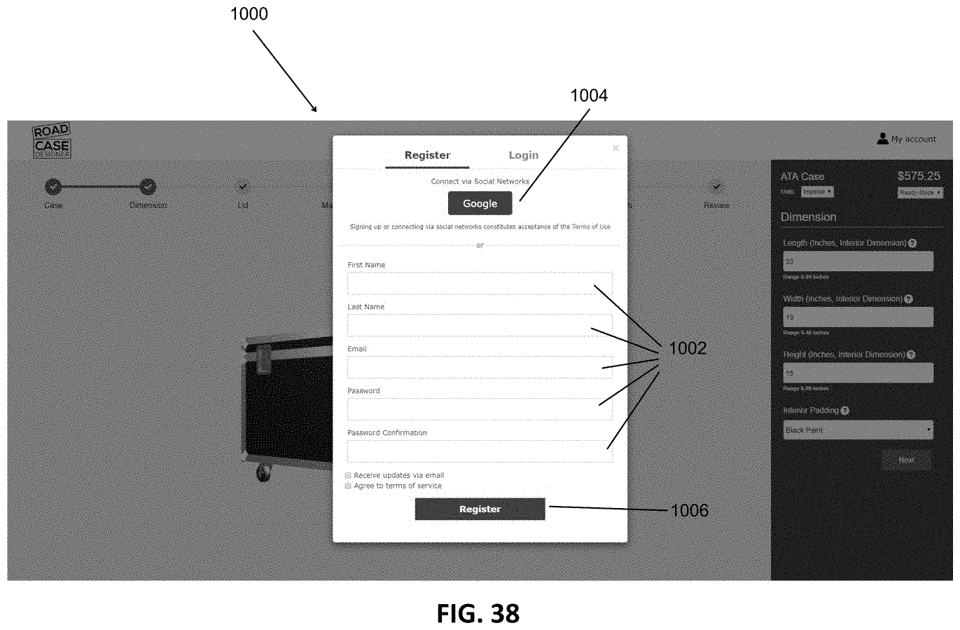

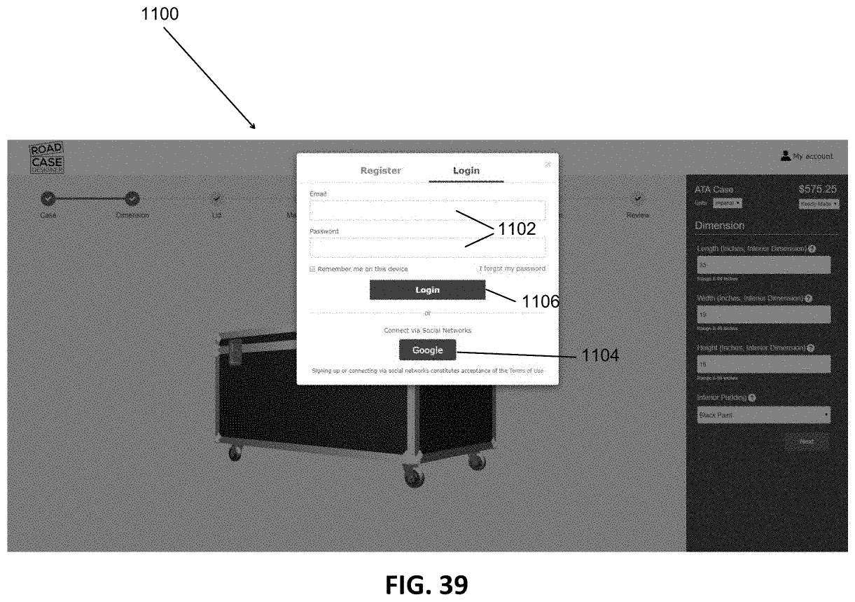

To use the system 300, the user establishes a registered account with the system 300 using a registration screen 1000, as shown in FIG. 38. The registration screen 1000 may include input fields 1002 for the user to input a first and last name, an associated E-mail address, and a password as well as a password confirmation, with such input information being sent to and stored by the database 322. The registration screen 1000 may also include an icon 1004 such as an icon labeled “Google” for allowing a user to register with the system 300 by connecting to social media and downloading such input information automatically into the input fields 1002. Once the input fields 1002 are filled, the user may optionally check a box to receive updates via E-mail, and the user may be required to check another box for indicating that the user agrees to terms of service of the system 300. If the user does not check the agreement checkbox, the user may be denied access to the system 300. With the input fields 1002 filled and the agreement checkbox checked, the user then presses an icon 1006 labeled “Register” to initiate registration of the user with the system 300.

A registered user is then capable of logging into the system 300 using the user computer 318 which displays a login screen 1100, by which a user inputs a username/E-mail address and a password into input fields 1102. The login screen 1002 may also include an icon 1004 such as an icon labeled “Google” for allowing a user to log into the system 300 by connecting to social media and downloading such input information automatically into the input fields 1102. The login screen 1100 may also include a checkbox to indicate that the system 300 is to remember the user on the associated user computer 318 through which the login screen 1100 is displayed. The login screen 1100 may further include a hyperlink labeled “I forgot my password” to enable the user to recover or to reset a forgotten password associated with the user and the username/E-mail inputted into the input fields 1102. In addition, the login screen 1100 includes an icon 1106 labeled “Login” such that, with the input fields 1102 filled and the optional “Remember me on this device” checkbox checked, the user then presses the icon 1106 to initiate login of the user with the system 300.

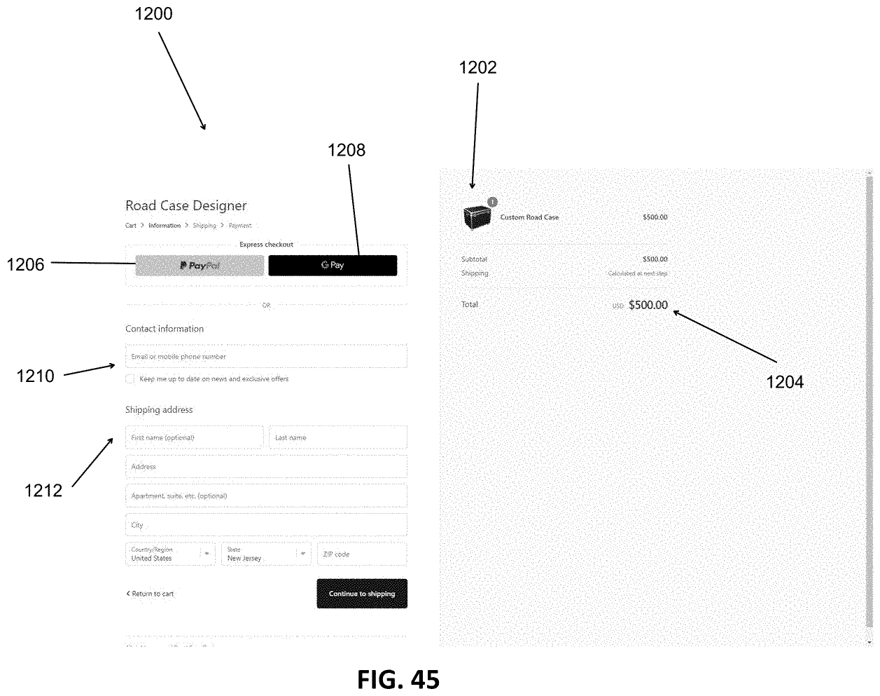

The profile screen 700 also includes a region 718 for viewing and/or editing packaging details as products, including the name of the packaging and a final price of the packaging. The region 718 also includes an Add to Cart region 720 having a plus sign icon and a minus sign icon for allowing a user to add or remove the currently displayed packaging to or from the shopping cart, respectively. The region 718 also includes a Favorites icon 722 for adding the currently displayed packaging to a favorite packaging list associated with the user and maintained in the database 322. The region 718 further includes a control 724, which may be an up arrow, a down arrow, and/or a scroll bar for scrolling through and displaying additional packagings associated with the user. A shopping cart icon 726 indicates, with a numerical indicia, how many packagings are in the shopping cart associated with the user. Actuating or clicking on the shopping cart icon 726 in FIG. 34, or alternatively actuating or clicking the shopping cart icon 160 in FIG. 21, described above, causes the processor 314 to display a shopping cart screen 1200, as shown in FIG. 45, which represents a shopping cart associated with the user, such as the shopping cart 155 of FIG. 22, described above. The shopping cart screen 1200 displays the packagings 1202 selected by the user for purchase, with the associated price 1204 to be paid. Through the shopping cart screen 1200, a user completes an order for a selected packaging, for example, to activate an express checkout function to process payment through PayPal or Google Pay (GPay) using the respectively labeled icons 1206, 1208. Otherwise, the user specifies associated contact information 1210 and a shipping address 1212. Once an order is completed and paid, the user receives an order confirmation E-mail, at the E-mail address associated with the user in the database 322, with the order confirmation E-mail providing details of the custom designed packaging and optionally a screenshot of a custom designed foam insert which fits into the custom designed packaging.

In addition, once logged into the system 300, the user can implement any configuration changes to a selected packaging as a user-associated product or project. For example, once the user scrolls through the packagings associated with the user using a control or icon, and displays a selected packaging in the region 718, the user can change the packaging. For example, the user may actuate or click on the region 718 and the system 300 will then display the GUIs shown in FIGS. 28-31 to permit the user to view and change the various settings and parameters of the packaging. In addition, by clicking on or otherwise selecting the downward facing arrow 724 in FIG. 34, the user can cause the system 300 to expand the displayed webpage to further display the specifications of the selected product.

As the user implements such changes, the updated packaging and its settings and parameters are automatically saved in the database 322 such that the updated packaging is associated with the account of the registered user, and can be accessed by the user in the future. Such automatically saving of updated packaging and its settings and parameters allows for a better user experience as the user can access saved packagings in the future with no need to rely on a user selecting a button to trigger the saving of an updated packaging.

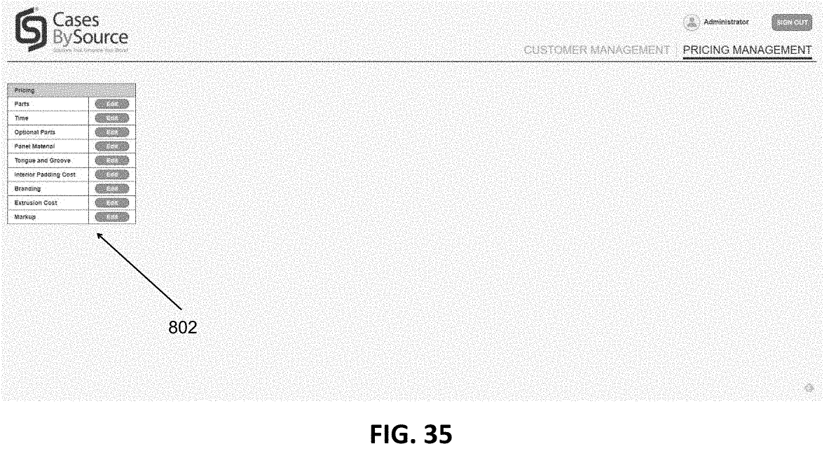

FIG. 35 shows a pricing management screen 800 with selectable icons 802, which is accessed by pressing a hyperlink labeled “PRICING MANAGEMENT” on a home page of the administrator. Using the price management screen 800, an administrator can access price information of parts; time such as labor costs; optional parts; panel material; tongue and groove/male-female portions of the metallic reinforced edges and corners; interior padding costs; branding; extrusion cost for the aluminum or metallic hardware, which is used to put together the wooden panels in order to build a case as a packaging; and markup, which is a percentage or fraction used to multiple the cost of goods in order to get to a final sale price.

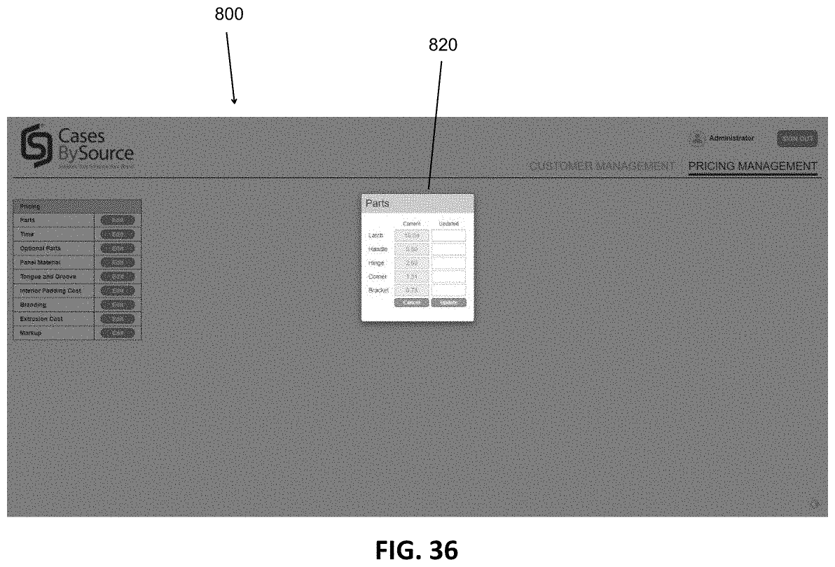

For example, when actuating or clicking on the Edit icon adjacent to the text “Parts”, a pop-up window 820 is displayed as shown in FIG. 36, which overlays the pricing management screen 800, and which allows a user, such as an administrator, to view a current price, and to update a selected price, such as prices for the latch, handle, hinge, corner, and bracket of the packagings created using the system 300. Accordingly, component and labor costs performed which are updatable using the pricing management screen 800 and functionality, as opposed to hard coding of cost values, allows for the easy update if the cost of a specific part or piece of hardware, or the cost of labor, increases or decreases.

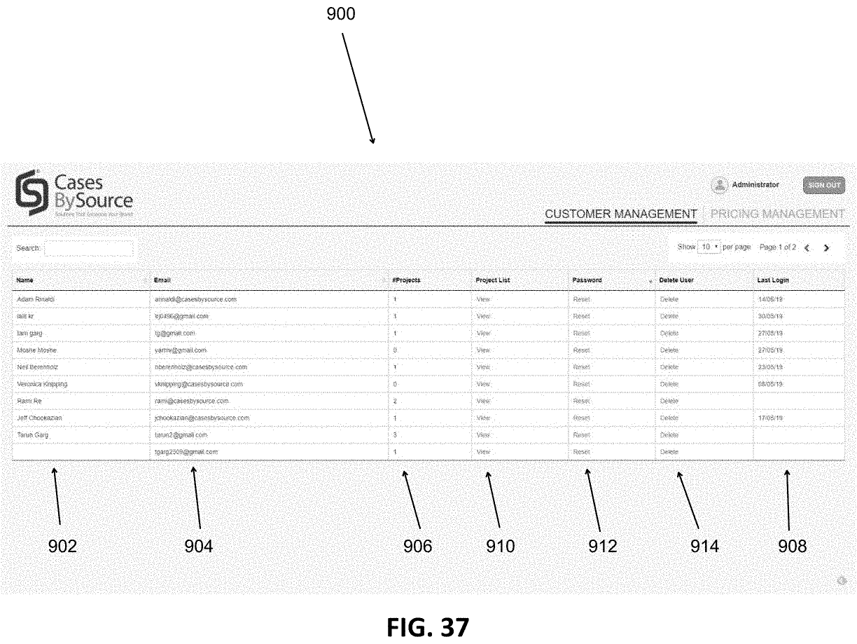

FIG. 37 shows an example customer management screen 900, as an administration GUI, for allowing an administrator to manage and control the users accessing the system 300. The customer management screen 900 is accessed by pressing a hyperlink labeled “CUSTOMER MANAGEMENT” on a home page of the administrator. Through the customer management screen 900, an administrator can change user data stored in the database 322. For example, the administration screen 900 displays the names 902 of users such as customers associated with the system 300, as well as the respective E-mail address 904, number of projects 906, and the last login time and/or date 908 of each user. Actuatable or clickable hyperlinks are associated with each respective name for viewing 910 a project list, for resetting 912 a password of a user, and for deleting 914 a user from the system 300, and therefore preventing the deleted user from using the system 300. For example, an administrator may delete a user who does not pay for a packaging which the user created using the system 300 and ordered through the system 300.

In an alternative embodiment, the system 300 is accessed through a website landing page of the website 316 or through a product page to allow a user to choose from at least one pre-selected packaging style, which may be displayed on the website 316 or product page. The choice of the user causes the processor 314 to load a default configuration, saved in the database 322, into the system 300. For example, a road case may have a first predetermined configuration of being top-loading with a hinged lid, a second predetermined configuration of being top-loading with a lid removable from the top, and a third predetermined configuration of having a side door. Each of the first, second, and third predetermine configuration has a set of default settings for the shape, size, and features of the road case. Upon selection of a predetermined configuration, the system 300 causes the designer application software to be launched by the processor 314, and loads the default settings of the selected predetermined configuration into the processor 314. Such predetermined configurations improve the experience of the user by enabling the user to start designing a custom road case or packaging without having to manually build a desired configuration every time. By using predetermined configurations, the user is allowed to quickly start with a desired initial configuration, and then customize the initial configuration to meet the requirements of the user.

The website 316 may be a general webpage displaying the GUIs described above. Alternatively, the website 316 may be customized or re-skinned to licensed companies, allowing the company to be indicated to the user using the system 300. In re-skinning the website 316, the system 300 and associated application software may be integrated into a company-based website, and so the frontend of the system 300 can have a logo and/or color theme of a licensing company. In addition, the company licensing the system 300 may have access to its own instance of the administration GUIs and administrative functions described above. Alternatively, the company may have limited access to such administrative aspects of the system 300, while the system 300 retains access to master administration orders for all instances of companies licensing the system 300.

A further embodiment includes generation of a Drawing Interchange Format (DXF) file to allow for seamless manufacturing by the manufacturing system 330. For example, when the user has completed a custom packing design, a DXF file is generated by the software application run by the processor 311, and stored in memory, such as in the database 322. The DXF file specifies the representation such as a drawing or 3D rendering of the custom-designed packaging, which enables the manufacturing system 330 to manufacture the packaging accordingly to custom designers, such as user wishing to purchase a customized packaging. For example, the manufacturing system 330 may include a computer numerical control (CNC) based manufacturing machine which uses the DXF file to seamlessly cut and create the parts of the custom-designed packaging. Alternatively or in addition, the manufacturing system 330 may include a 3D printer using the DXF file for additive manufacturing of parts and/or the entire custom-designed packaging.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and programmable logic devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations may be within the scope of the following claims.

In exemplary embodiments, the method 10 may be implemented in hardware, software, firmware, or any combination thereof in a form of a computer program product comprising one or more computer-executable instructions. When implemented in software, the computer program product may be stored on or transmitted using a computer-readable medium, which includes computer storage medium and computer communication medium. The term “computer storage medium” refers herein to any medium adapted for storing the instructions that cause the computer to execute the method. By way of example, and not limitation, the computer storage medium may comprise solid-sate memory devices, including electronic memory devices (e.g., RAM, ROM, EEPROM, and the like), optical memory devices (e.g., compact discs (CD), digital versatile discs (DVD), and the like), or magnetic memory devices (e.g., hard drives, flash drives, tape drives, and the like), or other memory devices adapted to store the computer program product, or a combination of such memory devices.

The term “computer communication medium” refers herein to any physical interface adapted to transmit the computer program product from one place to another using for example, a modulated carrier wave, an optical signal, a DC or AC current, and the like means. By way of example, and not limitation, the computer communication medium may comprise twisted wire pairs, printed or flat cables, coaxial cables, fiber-optic cables, digital subscriber lines (DSL), or other wired, wireless, or optical serial or parallel interfaces, or a combination thereof.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

The present invention may be embodied in other specific forms without departing from its spirit or essential characteristics. The described embodiments are to be considered in all respects only as illustrative and not restrictive. The scope of the invention, therefore, will be indicated by claims rather than by the foregoing description. All changes, which come within the meaning and range of equivalency of the claims, are to be embraced within their scope.

What is claimed is:

1. A method for creating packaging for retaining an object comprising the steps of:
selecting overall dimensions of the packaging using an input device;
selecting a component of the packaging using the input device; and
manufacturing the packaging having the overall dimensions and the component using a manufacturing system, thereby creating the packaging.

2. The method of claim 1, wherein the selecting of the overall dimensions of the packaging includes the step of:
selecting interior dimensions of a cavity within the packaging.

3. The method of claim 1, wherein the step of selecting the component includes the step of:
selecting an interior padding of the packaging.

4. The method of claim 1, wherein the step of selecting the component includes the step of:
selecting a lid of the packaging.

5. The method of claim 1, wherein the step of selecting the component includes the step of:
selecting a material from which the packaging is composed.

6. The method of claim 1, wherein the step of selecting the component includes the step of:
selecting a wheel of the packaging.

7. The method of claim 1, wherein the step of selecting the component includes the step of:
selecting a branding of the packaging.

8. The method of claim 1, further comprising the step of:
displaying details about the overall dimensions and the component for review on an output device.

9. The method of claim 1, wherein the steps of selecting the overall dimensions and selecting the component are performed using a web-based service.

10. The method of claim 1, wherein the steps of selecting the overall dimensions and selecting the component are performed using a graphical user interface (GUI).

11. A system for creating packaging for retaining an object comprising:
an input device for allowing a user to select overall dimensions of the packaging and to select a component of the packaging; and
a manufacturing system for manufacturing the packaging having the overall dimensions and the component, thereby creating the packaging.

12. The system of claim 11, further comprising:
a web server for implementing a web-based service for selecting the overall dimensions and selecting the component.

13. The system of claim 11, further comprising:
an output device for displaying details about the overall dimensions and the component for review.

14. The system of claim 13, wherein at least one of the input device and the output device includes a graphical user interface (GUI).

15. A method for manufacturing a custom foam insert insertable into a packaging for an object comprising the steps of:
displaying a graphical user interface (GUI) on an input/output device;
displaying a template on the GUI to instruct the user to place the object to be packaged in the packaging on a flat surface in a layout;
designing the custom foam insert using the GUI, the custom foam insert including a cavity corresponding to a feature of the object; and
manufacturing the custom foam insert using a manufacturing system, wherein the custom foam insert is sized to be received in the packaging, and the custom foam insert is adapted to receive the object.

16. The method of claim 15, wherein the step of designing the custom foam insert further comprises the steps of:
launching a pop-up foam type window on the GUI for displaying a plurality of foam types which can be selected by the user; and
selecting one of the displayed foam types.

17. The method of claim 15, wherein the step of designing the custom foam insert further comprises the steps of:
uploading a photograph of the object;
creating a trace representation of the uploaded photograph on the GUI; and
saving the trace representation as an insert representation to a memory as a data file in a library associated with the user.

18. The method of claim 17, wherein the uploaded photograph is a bitmap, and the step of creating the trace representation converts the bitmap to vector graphics.

19. The method of claim 17, wherein the step of creating the trace representation of the uploaded photograph further comprises the steps of:
displaying an input object depth template and an input object length template on the GUI;
inputting a depth of the object in the input depth template and a length of the object in the input object length template; and
scaling the trace representation using the depth and the length.

20. The method of claim 15, further comprising the steps of:
displaying a starting canvas on the GUI; and
sizing the starting canvas to a predetermined value.
